(19) United States
(12) Patent Application Publication
(10) Pub. No.: US 2010/0295678 A1
(43) Pub. Date: Nov. 25, 2010

(54) MOBILE APPARATUS, METHOD OF CONTROLLING THE SAME, AND PROGRAM

(76) Inventors: Shiro Suzuki, Kanagawa (JP); Akira Inoue, Tokyo (JP); Chisato Kemmochi, Kanagawa (JP); Kyosuke Matsumoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/780,224

(22) Filed: May 14, 2010

(30) Foreign Application Priority Data
May 22, 2009 (JP) P2009-123995

(51) Int. Cl. G08B 21/18

(52) U.S. Cl. 340/540

(57) ABSTRACT

Provided is a notice apparatus including: a plurality of notice signal generation units which generate notice signals; a reference signal output unit which outputs a reference signal used to determine an environmental situation; a reference signal detection unit which detects the reference signal output from the reference signal output unit and generates the detected reference signal as a detection signal; and a notice controller which controls one of the notice signal generation units to generate the notice signal based on the detection signal generated by the reference signal detection unit.

### BACKGROUND OF THE INVENTION

1. Field of the Present Invention

The present invention relates to a mobile apparatus, and more particularly, to a mobile apparatus having a plurality of operation modes, a method of controlling the same, and a program executing the method on a computer.

2. Description of the Related Art

In the related art, a mobile phone having a call incoming function of notifying an incoming call to a user by a plurality of notice operations using a vibration or a sound wave, as the call incoming function of the mobile phone, has been generally used when the mobile phone detects the incoming call. With respect to the mobile phone having such a function, the notice operation may have to be set in advance according to an environment situation by the user. On the other hand, a mobile phone of which the notice operation is switched based on a position of the mobile phone has been contrived. For example, Japanese Unexamined Patent Application Publication No. 2002-330470 (FIG. 1) discloses a mobile phone, where it is determined whether or not a position detected by a detection means for detecting a current position of the mobile phone is within a pre-designated area and the notice operation is switched based on a result of the determination.

In the aforementioned technology, the notice operation may be switched according to the position of the mobile phone. Therefore, for example, a position of an office and the notice operation for the position of office are designated, and in the vicinity of the office, the notice operation of the mobile phone is switched to the designated notice operation. In such a mobile phone, information on the position of the mobile phone may have to be acquired from an external apparatus. However, in an indoor position or a large-building congested area, the information on the position of the mobile phone may not be acquired from the external apparatus. In this case, there is a problem in that the notice operation of the mobile phone may not be switched.

### SUMMARY OF THE INVENTION

It is desirable to switch a notice operation according to an environment situation irrespective of information supplied from an external apparatus.

According to a first embodiment of the present invention, there is provided a notice apparatus including: a plurality of notice signal generation units which generate notice signals; a reference signal output unit which outputs a reference signal used to determine an environment situation; a reference signal detection unit which detects the reference signal output from the reference signal output unit and generates the detected reference signal as a detection signal; and a notice controller which controls one of the notice signal generation units to generate the notice signal based on the detection signal generated by the reference signal detection unit, a method of handling the same, and a program causing a computer to execute the method. Accordingly, the reference signal output from the reference signal output unit is detected, and the environment situation is determined based on the detected detection signal, so that one of the notice signal generation units may be allowed to generate the notice signal.

In addition, in the first embodiment, the reference signal output unit may output a sound signal as the reference signal, the reference signal detection unit may detect the sound signal output from the reference signal output unit and generate the detected sound signal as the detection signal, and the notice controller may control one of the notice signal generation units to generate the notice signal based on the detection sound signal generated as a detection signal by the reference signal detection unit. Accordingly, the sound signal generated from the sound wave is output as the reference signal, and the output sound signal is detected, so that it may be determined whether or not the environment is surrounded by a shielding object. In this case, the notice controller may control one of the notice signal generation units to generate the notice signal based on a magnitude of the detection sound signal. Accordingly, it may be determined based on the magnitude of the detection sound signal corresponding to the strength of the sound wave whether or not the environment of the notice apparatus is covered.

In addition, in the case where the reference signal output unit outputs the sound signal as the reference signal, the reference signal detection unit detects the sound signal output from the reference signal output unit, and the notice controller controls one of the notice signal generation units to generate the notice signal based on the detection sound signal generated as the detection signal by the reference signal detection unit, the notice controller may control one of the notice signal generation units to generate the notice signal based on frequency components of the detection sound signal. Accordingly, it may be determined based on a distribution of the frequency components of the detection signal whether or not the environment of the notice apparatus is covered.

In addition, in the case where the reference signal output unit outputs the sound signal as the reference signal, the reference signal detection unit detects the sound signal output from the reference signal output unit, and the notice controller controls one of the notice signal generation units to generate the notice signal based on the detection sound signal generated as the detection signal by the reference signal detection unit, the reference signal output unit may output the sound signal constructed with predetermined frequency components, and the notice controller may control one of the notice signal generation units to generate the notice signal based on the predetermined frequency components of the detection sound signal. Accordingly, the sound signal constructed with a plurality of the frequency components is detected, so that it may be determined based on the sound wave attenuation characteristic due to a shielding object covering the notice apparatus whether or not the environment is surrounded. In this case, the reference signal output unit may output the sound signal constructed with the frequency components outside a voice band. Accordingly, the sound signal constructed with inaudible frequency components which are not easily heard by human may be output.

In addition, in the first embodiment, the reference signal output unit may output the reference signal generated based on vibration, the reference signal detection unit may detect the vibration output from the reference signal output unit and generates the detected vibration as the detection signal, and the notice controller may control one of the notice signal generation units to generate the notice signal based on a detection vibration signal generated as the detection signal by the reference signal detection unit. Accordingly, the reference signal generated from the vibration is detected, so that it may be determined whether or not the contact material being in contact with the notice apparatus is hard. In this case, the notice controller may control one of the notice signal generation units to generate the notice signal based on a magnitude of the detection vibration signal. Accordingly, it may be determined based on the magnitude of the detection vibration signal corresponding to the amplitude of the vibration whether the contact material being in contact with the notice apparatus is hard or soft.

In addition, in the first embodiment, in the case where the reference signal output unit outputs the reference signal generated based on the vibration, the reference signal detection unit detects the vibration output from the reference signal output unit, and the notice controller controls one of the notice signal generation units to generate the notice signal based on the detection vibration signal generated as the detection signal by the reference signal detection unit, the notice controller may control one of the notice signal generation units to generate the notice signal based on frequency components of the detection vibration signal. Accordingly, it may be determined based on the frequency components other than the vibration frequency of the reference signal generated from the contact material whether or not the contact material is hard.

In addition, in the first embodiment, in the case where the reference signal output unit outputs the reference signal generated based on the vibration, the reference signal detection unit detects the vibration output from the reference signal output unit, and the notice controller controls one of the notice signal generation units to generate the notice signal based on the detection vibration signal generated as the detection signal by the reference signal detection unit, the notice signal generation unit may generate the notice vibration signal as the notice signal to generate the vibration for notice, and the reference signal output unit may output the vibration of which a magnitude is smaller than a magnitude of the notice vibration generated based on the notice vibration signal. Accordingly, the vibration, which is not easily perceived by a user in comparison with the notice vibration generated from the notice vibration signal, may be output as the reference signal.

According to the invention, it is possible to obtain an excellent advantage in that a notice operation may be switched according to an environment situation irrespective of information from an external apparatus.

### BRIEF DESCRIPTION OF THE DRAWINGS

FIG. 1 is an outer appearance view illustrating an outer appearance of a mobile phone according to a first embodiment of the invention.

FIG. 2 is a block diagram illustrating an example of a configuration of the mobile phone according to the first embodiment of the invention.

FIG. 3 is a diagram illustrating an example of a configuration of a call-incoming mode switching unit according to the first embodiment of the invention.

FIGS. 4A and 4B are diagrammatic views illustrating an example of detection of a reference signal by the mobile phone according to the first embodiment of the invention.

FIG. 5 is a diagram illustrating an example of environment determination of the mobile phone based on a magnitude of a detection sound signal by an environment determination unit according to the first embodiment of the invention.

FIG. 6 is a flowchart illustrating an example of a procedure of a call incoming notice method of the mobile phone according to the first embodiment of the invention.

FIG. 7 is a flowchart illustrating an example of a procedure of an environment determination process by the call-incoming mode switching unit according to the first embodiment of the invention.

FIG. 8 is a block diagram illustrating an example of a configuration of a call-incoming mode switching unit according to a second embodiment of the invention.

FIGS. 9A and 9B are diagrams illustrating an example of environment determination based on a frequency component of a measurement signal by the call-incoming mode switching unit according to the second embodiment of the invention.

FIG. 10 is a flowchart illustrating an example of a procedure of an environment determination process by a call-incoming mode switching unit according to the second embodiment of the invention.

FIG. 11 is an outer appearance view illustrating an outer appearance of a mobile phone according to a third embodiment of the invention.

FIG. 12 is a block diagram illustrating an example of a configuration of the mobile phone according to the third embodiment of the invention.

FIG. 13 is a diagram illustrating an example of a configuration of a call-incoming mode switching unit according to the third embodiment of the invention.

FIGS. 14A and 14B are diagrammatic views illustrating an example of detection of vibration of the mobile phone based on a reference signal by the mobile phone according to the third embodiment of the invention.

FIG. 15 is a diagram illustrating an example of environment determination of the mobile phone based on a magnitude of a detection vibration signal by an environment determination unit according to the third embodiment of the invention.

FIG. 16 is a flowchart illustrating an example of a procedure of a notice control method by an environment determination function of the mobile phone according to the third embodiment of the invention.

FIG. 17 is a flowchart illustrating an example of a procedure of an environment determination process by the call-incoming mode switching unit according to the third embodiment of the invention.

FIG. 18 is a block diagram illustrating an example of a configuration of a call-incoming mode switching unit according to a fourth embodiment of the invention.

FIGS. 19A and 19B are diagrams illustrating an example of environment determination based on a frequency component of a measurement signal by the call-incoming mode switching unit according to the fourth embodiment of the invention.

FIG. 20 is a flowchart illustrating an example of a procedure of an environment determination process by the call-incoming mode switching unit according to the fourth embodiment of the invention.

FIG. 21 is a flowchart illustrating an example of a procedure of a notice control method by an environment determination function of a mobile phone according to a fifth embodiment of the invention.

### DESCRIPTION OF THE PREFERRED EMBODIMENTS

Hereinafter, exemplary embodiments of the invention are described. The description is made in the following order.

1. First Embodiment (Call-Incoming Mode Switching Control: Example of Determination Based on Level of Detection Sound Signal)

2. Second Embodiment (Call-Incoming Mode Switching Control: Example of Determination Based on Level of Frequency Component of Detection Sound Signal)

3. Third Embodiment (Call-Incoming Mode Switching Control: Example of Determination Based on Level of Detection Vibration Signal)

4. Fourth Embodiment (Call-Incoming Mode Switching Control: Example of Determination Based on Level of Frequency Component of Detection Vibration Signal)

5. Fifth Embodiment (Reference Signal Output Control: Example of Output of Reference Signal According to Motion Detection of Mobile Phone)

### 1. First Embodiment

### Example of Outer Appearance of Mobile Phone

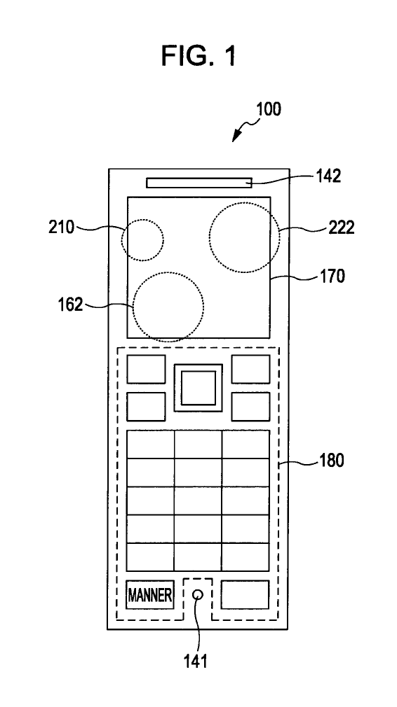

FIG. 1 is an outer appearance view illustrating an outer appearance of a mobile phone according to a first embodiment of the invention. In the figure, as an appearance of the front side of the mobile phone 100, a call-transmitting unit 141, a call-receiving unit 142, a display unit 170, and a manipulation reception unit 180 are illustrated. In addition, a vibration generation unit 162, a sound detection unit 210, and a speaker unit 222 which are disposed in an inner portion of the mobile phone 100 are illustrated by a dotted line.

The mobile phone 100 is a phone using an electromagnetic wave as an information transmission medium and a small-sized portable information terminal. The mobile phone 100 has main functions of a voice or video call function and a data communication function of reading a text or image e-mail or a text, an image, or a moving picture.

The call-transmitting unit 141 is a microphone for collecting voice, which is uttered by a user of the mobile phone 100 (hereinafter, referred to as a user), as a call-transmitting sound in a talking state. The call-receiving unit 142 is a speaker for converting a call-receiving signal, which is counterparty's voice signal, into a sound wave and outputting the sound wave to the user in the talking state.

The speaker unit 222 is a speaker for outputting a notice sound for notifying the user of the call incoming by using a sound wave when a phone call or a mail is received from a communication counterparty. The speaker unit 222 outputs the notice sound pre-designated by the user among a plurality of the notice sounds at the call incoming time.

In addition, the speaker unit 222 outputs a reference signal for determining environment situation of the mobile phone 100 as a sound signal, which is a sound wave. In addition, for example, when an internal clock of the mobile phone 100 is at a pre-designated time, the speaker unit 222 outputs an alarm sound.

The vibration generation unit 162 is a motor of generating notice vibration for vibrating the mobile phone 100. The vibration generation unit 162 notifies a user of call incoming by generating the notice vibration. For example, the vibration generation unit 162 generates notice vibration pre-designated by the user among a plurality of types of notice vibration at the call incoming time.

The display unit 170 is used to display various types of information such as a counterparty's phone number at the call incoming time, character or image. The display unit 170 may be implemented with, for example, LCD (liquid crystal display).

The manipulation reception unit 180 receives user's manipulation of various settings for the mobile phone 100. The manipulation reception unit 180 is constructed with, for example, number buttons for designating phone numbers, characters, or the like, a manner mode setting button for setting a manner mode, other function setting buttons, and the like.

The manipulation reception unit 180 receives manipulation for setting the call-incoming mode at the call incoming time, for example, by the function setting button. In other words, the manipulation reception unit 180 receives setting of one call-incoming mode among the notice sound mode for notifying the user of the call incoming by using the notice sound from the speaker unit 222 and the notice vibration mode for notifying the user of the call incoming by using the notice vibration generated from the vibration generation unit 162.

In addition, the manipulation reception unit 180 receives manipulation for setting the environment determination function by the function setting button. The environment determination function described herein denotes a function of switching the call-incoming mode according to the environment situation of the mobile phone 100. In addition, the manipulation reception unit 180 receives the counterparty's phone number at the call sending time, for example, by the numeric buttons.

The sound detection unit 210 is a microphone for detecting a reference signal output from the speaker unit 222 so as to determine the environment situation of the mobile phone 100 in the case where the environment determination function is set.

In this manner, in the case where the environment determination function is set, the mobile phone 100 allows the speaker unit 222 to output the reference signal and allows the sound detection unit 210 to detest the reference signal, so that the call-incoming mode is switched according to the environment of the mobile phone 100. Next, the configuration of the mobile phone 100 is described in detail with reference to the drawing.

### Example of Configuration of Mobile Phone 100

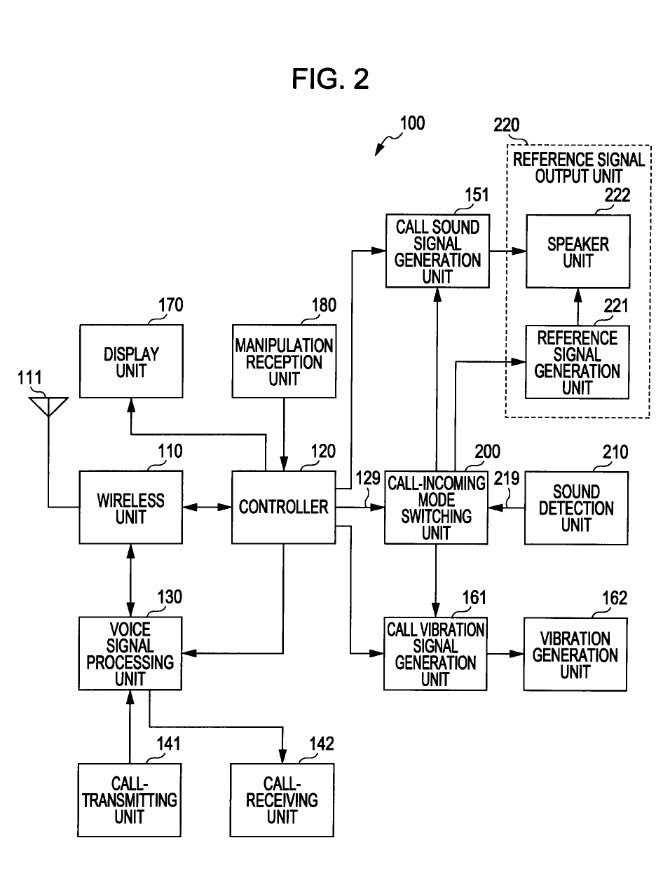

FIG. 2 is a block diagram illustrating an example of a configuration of the mobile phone 100 according to the first embodiment of the invention.

The mobile phone 100 includes an antenna 111, a wireless unit 110, a controller 120, a voice signal processing unit 130, a call-transmitting unit 141, a call-receiving unit 142, notice sound signal generation unit 151, a notice vibration signal generation unit 161, and a vibration generation unit 162. In addition, the mobile phone 100 further includes a display unit 170, a manipulation reception unit 180, a call-incoming mode switching unit 200, a sound detection unit 210, and a reference signal output unit 220. In addition, the reference signal output unit 220 includes a reference signal generation unit 221 and a speaker unit 222.

The antenna 111 is used to receive and transmit an electromagnetic wave as a high frequency signal in order to perform communication. The antenna 111 receives the electromagnetic wave from a radio communication station and supplies the received signal as a reception signal to the wireless unit 110. In addition, the antenna 111 transmits a transmission signal, which is supplied from the wireless unit 110, to the radio communication station.

The wireless unit 110 performs radio communication by receiving and transmitting information through an electromagnetic wave with respect to the radio communication station. The wireless unit 110 performs, for example, a frequency conversion process, a signal amplification process, a transmitting/receiving switching process, and a modulation/demodulation process. The wireless unit 110 demodulates the reception signal from the antenna 111 and supplies a call-receiving signal, which is a voice signal included in the demodulated signal, to the voice signal processing unit 130. In addition, the wireless unit 110 supplies information on a counterparty or an image signal included in the demodulated signal to the controller 120.

On the other hand, the wireless unit 110 modulates information on a call destination supplied from the controller 120 and a call-transmitting signal supplied from the voice signal processing unit 130 and transmits the modulated transmission signal through the antenna 111.

The controller 120 controls the mobile phone 100. In other words, the controller 120 controls the wireless unit 110, the voice signal processing unit 130, the notice sound signal generation unit 151, the notice vibration signal generation unit 161, the display unit 170, and the call-incoming mode switching unit 200. At the call sending time for making a phone call or transmitting a mail, the controller 120 supplies the information on the call destination designated by the manipulation reception unit 180 to the wireless unit 110.

The controller 120 sets the setting parameters, which are associated with the settings of the call-incoming mode received by the manipulation reception unit 180, to the notice sound signal generation unit 151 and the notice vibration signal generation unit 161. In other words, the controller 120 supplies the notice sound setting parameter indicating a sound volume or type of the notice sound of the call incoming time to the notice sound signal generation unit 151 and supplies the notice vibration setting parameter indicating a strength or type of the vibration of the call incoming time to the notice vibration signal generation unit 161.

In addition, when the reception signal is demodulated by the wireless unit 110, the controller 120 supplies the incoming call signal to the call-incoming mode switching unit 200 through a control line 129. At the same time, for example, the controller 120 displays the call incoming window pre-designated by the user or the phone number of the call destination on the display unit 170.

In addition, the controller 120 displays a setting menu window, on which settings of various functions of the mobile phone 100 are performed, on the display unit 170 according to user's manipulation of the manipulation reception unit 180. In the case where the environment determination function is set by the manipulation reception unit 180, the controller 120 allows the call-incoming mode switching unit 200 to perform an environment determination process.

In addition, the controller 120 displays an image signal or text information supplied from, for example, the wireless unit 110 on the display unit 170 according to user's manipulation of the manipulation reception unit 180. In addition, the controller 120 is implemented with, for example, a digital signal processor (DSP).

The voice signal processing unit 130 applies a predetermined voice signal process on the call-receiving signal and the call-transmitting signal in the talking state. The voice signal processing unit 130 applies processes such as a decoding process on the call-receiving signal supplied from the wireless unit 110 and supplies the call-receiving signal, which is subjected to the above processes, to the call-receiving unit 142.

In addition, the voice signal processing unit 130 applies processes such as an encoding process on the call-transmitting signal generated by the call-transmitting unit 141 and supplies the call-transmitting signal, which is subjected to the above processes, to the wireless unit 110. In addition, the voice signal processing unit 130 is constructed with, for example, a digital signal processor (DSP).

The call-transmitting unit 141 is a microphone for collecting voice uttered by a user as described with reference to FIG. 1. In other words, the call-transmitting unit 141 converts the collected voice to an electric signal and supplies the converted electric signal as a call-transmitting signal to the voice signal processing unit 130.

The call-receiving unit 142 is a speaker for outputting a call-receiving signal supplied from the voice signal processing unit 130 as described with reference to FIG. 1. In other words, the call-receiving unit 142 converts the call-receiving signal to a sound wave and output the converted call-receiving sound to the user.

The notice sound signal generation unit 151 is a notice signal generation unit for generating a notice sound signal as a notice signal based on a notice sound setting parameter supplied from the controller 120 according to an instruction of the call-incoming mode switching unit 200. In the case where the call-incoming mode in the call-incoming mode switching unit 200 is set to a notice sound mode, the notice sound signal generation unit 151 generates the notice sound signal based on the notice sound setting parameter so as to notify the user of the call incoming by using a sound. The notice sound signal generation unit 151 supplies the generated notice sound signal to the speaker unit 222. In addition, the notice sound signal generation unit 151 is an example of a notice signal generation unit disclosed in Claims.

The notice vibration signal generation unit 161 is a notice signal generation unit for generating a notice vibration signal as a notice signal based on a notice vibration setting parameter supplied from the controller 120 according to an instruction of the call-incoming mode switching unit 200. In the case where the call-incoming mode in the call-incoming mode switching unit 200 is set to a notice vibration mode, the notice vibration signal generation unit 161 generates the notice vibration signal based on the notice vibration setting parameter so as to notify the user of the call incoming by using the vibration. In addition, notice vibration signal generation unit 161 supplies the generated notice vibration signal to the vibration generation unit 162. In addition, the notice vibration signal generation unit 161 is an example of a notice signal generation unit disclosed in Claims.

The vibration generation unit 162 generates the notice vibration based on the notice vibration signal generated by the notice vibration signal generation unit 161. For example, in the case where the call-incoming mode in the call-incoming mode switching unit 200 is set to the notice vibration mode, when the incoming call is received, the vibration generation unit 162 generates the notice vibration.

The display unit 170 displays various types of information by performing an image signal process on a signal supplied from the controller 120.

In the case where the environment determination function is set, the call-incoming mode switching unit 200 determines the environment of the mobile phone 100 based on the detection sound signal supplied from the sound detection unit 210 and switches the call-incoming mode according to the result of the determination. In other words, in the case where the environment determination function is set, when the incoming call signal is supplied from the controller 120, the call-incoming mode switching unit 200 notifies the user that there is an incoming call according to the call-incoming mode which is switched based on the detection sound signal.

In the case where the environment determination function is set, the call-incoming mode switching unit 200 controls one of the notice sound signal generation unit 151 and the notice vibration signal generation unit 161 to generate the notice signal, for example, based on a magnitude of the detection sound signal. In this case, the call-incoming mode switching unit 200 controls one of the notice sound signal generation unit 151 and the notice vibration signal generation unit 161 to generate the notice sound signal or the notice vibration signal, for example, based on the frequency component of the detection sound signal.

In the case where the environment determination function is set, when the incoming call signal is supplied from the controller 120, the call-incoming mode switching unit 200 instructs one of the notice sound signal generation unit 151 and the notice vibration signal generation unit 161 to generate the notice signal. In addition, in the case where the environment determination function is set, the call-incoming mode switching unit 200 switches the call-incoming mode, for example, based on the detection sound signal and at the same time, changes the setting parameter in the switched call-incoming mode based on the detection sound signal.

In addition, in the case where the environment determination function is set, the call-incoming mode switching unit 200 instructs the reference signal generation unit 221 to generate a signal for outputting the reference signal from the speaker unit 222. In this case, the call-incoming mode switching unit 200 instructs the reference signal generation unit 221 to generate the signal for outputting the reference signal from the speaker unit 222, for example, in a predetermined time interval.

The sound detection unit 210 is a microphone for detecting the sound signal, which is the reference signal output from the speaker unit 222, so as to determine the environment situation of the mobile phone 100 as described with reference to FIG. 1. In other words, the sound detection unit 210 detects the reference signal output from the reference signal output unit 220. In addition, the sound detection unit 210 generates a detection sound signal which is a detection signal, by converting the detected sound signal to an electric signal. In addition, the sound detection unit 210 supplies the generated detection sound signal through a detection signal line 219 to the call-incoming mode switching unit 200. In addition, the sound detection unit 210 is an example of a reference signal detection unit disclosed in Claims.

The reference signal output unit 220 is used to output the sound signal which is the reference signal for determining the environment situation of the mobile phone 100. In addition, the reference signal output unit 220 is an example of a reference signal output unit disclosed in Claims.

The reference signal generation unit 221 is used to generate a signal for outputting the sound signal which is the reference signal from the speaker unit 222. The reference signal generation unit 221 generates a signal for outputting the reference signal from the speaker unit 222 according to an instruction from the call-incoming mode switching unit 200. The reference signal generation unit 221 generates a signal for outputting the reference signal from the speaker unit 222 in a predetermined time interval according to an instruction from the call-incoming mode switching unit 200.

In addition, the reference signal generation unit 221 generates a signal for outputting the reference signal, which is constructed with a plurality of frequency components, from the speaker unit 222. The reference signal generation unit 221 generates the signal for outputting from the speaker unit 222 the reference signal constructed with the frequency components, which may not be easily heard by human, for example, the reference signal constructed with the frequency components other than a voice band (350 Hz to 7 kHz).

In addition, for example, in order that a user is allowed not to be worried about the reference signal, the reference signal generation unit 221 adjusts the sound volume of the reference signal based on the sound volume pre-designated by the user. In other words, the reference signal generation unit 221 adjusts the reference signal so that the sound volume is smaller than the sound volume of the notice sound pre-designated by the user. Alternatively, the reference signal generation unit 221 may generate the reference signal of the sound of which type is different from that of the notice sound so that the reference signal and the notice sound can be easily distinguished by the user. In addition, the reference signal generation unit 221 supplies the signal, which is used for outputting the reference signal from the speaker unit 222, to the speaker unit 222.

The speaker unit 222 is a speaker for outputting a sound wave based on the signal generated by the reference signal generation unit 221 or the notice sound signal generation unit 151. The speaker unit 222 outputs the sound signal, which is the reference signal, based on the signal from the reference signal generation unit 221. In addition, speaker unit 222 outputs the notice sound based on the notice sound signal supplied from the notice sound signal generation unit 151.

In addition, in the case where the environment determination function is set, the speaker unit 222 outputs the reference signal based on a signal supplied from the reference signal generation unit 221 in a predetermined time interval. In addition, in the case where the call-incoming mode is set to the notice sound mode in the call-incoming mode switching unit 200, when the incoming call signal is supplied, the speaker unit 222 outputs the notice sound.

In this manner, the sound detection unit 210 and the reference signal output unit 220 are provided, so that the call-incoming mode switching unit 200 determines the environment of the mobile phone 100 based on the detection sound signal from the sound detection unit 210 and switches the call-incoming mode according to the result of the determination. Next, an example of the configuration of the call-incoming mode switching unit 200 is described in detail with reference the drawings.

### Example of Configuration of Call-Incoming Mode Switching Unit 200

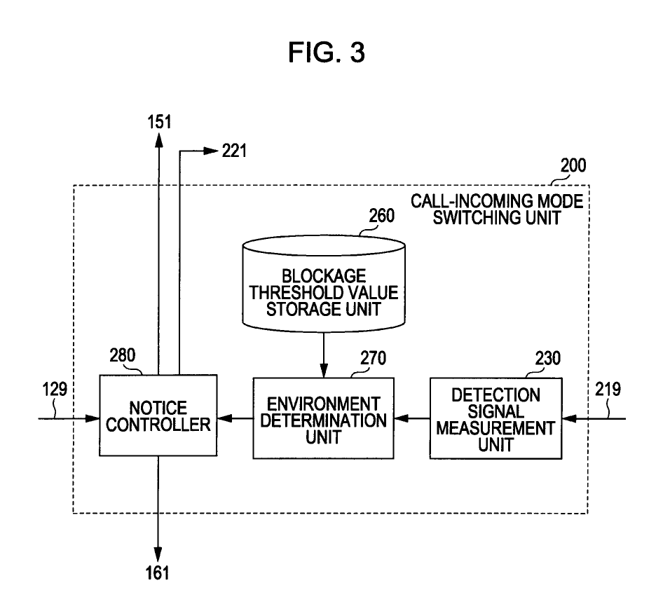

FIG. 3 is a diagram illustrating an example of a configuration of the call-incoming mode switching unit 200 according to the first embodiment of the invention. Herein, it is assumed that the environment determination function is set in advance by the user.

The call-incoming mode switching unit 200 includes a detection signal measurement unit 230, a blockage threshold value storage unit 260, an environment determination unit 270, and a notice controller 280.

The detection signal measurement unit 230 is used to measure a magnitude of the detection sound signal supplied through the detection signal line 219 from the sound detection unit 210. In other words, the detection signal measurement unit 230 measures the strength of the sound wave of the reference signal by a predetermined unit. In addition, the detection signal measurement unit 230 supplies the measured detection sound signal as the measurement signal to the environment determination unit 270. The detection signal measurement unit 230 converts the detection signal into, for example, a voltage signal and supplies the converted voltage signal to the environment determination unit 270.

The blockage threshold value storage unit 260 stores a blockage threshold value used to determine whether or not the environment of the mobile phone 100 is surrounded. The blockage threshold value storage unit 260 outputs the stored blockage threshold value to the environment determination unit 270.

The environment determination unit 270 determines based on the signal level of the measurement signal supplied from the detection signal measurement unit 230 and the blockage threshold value stored in the blockage threshold value storage unit 260 whether or not the mobile phone 100 is surrounded by a shielding object. For example, in the case where the signal level of the measurement signal from the detection signal measurement unit 230 is smaller than the blockage threshold value, the environment determination unit 270 determines the environment to be in the blocked state, where the environment of the mobile phone 100 is surrounded. On the other hand, in the case where the signal level of the measurement signal from the detection signal measurement unit 230 is equal to or larger than the blockage threshold value, the environment determination unit 270 determines the environment to be in the open state, where the environment of the mobile phone 100 is not surrounded.

In addition, the environment determination unit 270 supplies the determined result of the determination to the notice controller 280. As an example of the result of the determination, in the case where the environment is determined to be in the blocked state, the environment determination unit 270 generates the determination information indicating the blocked state. In the case where the environment is determined to be in the open state, the environment determination unit 270 generates the determination information indicating the open state. Next, the environment determination unit 270 supplies the generated determination information as the result of the determination to the notice controller 280.

In the case where the incoming call signal is supplied from the control line 129, the notice controller 280 allows one of the notice sound signal generation unit 151 and the notice vibration signal generation unit 161 to generate the notice signal according to the call-incoming mode determined by the result of the determination of the environment determination unit 270. In other words, the notice controller 280 controls one notice signal generation unit among a plurality of the notice signal generation units to generate the notice signal based on a magnitude of the detection sound signal generated by the sound detection unit 210.

The notice controller 280 updates the call-incoming mode based on the result of the determination of the environment determination unit 270. Next, in the case where the incoming call signal is supplied from the controller 120, the notice controller 280 instructs one of the notice sound signal generation unit 151 and the notice vibration signal generation unit 161 to generate the notice signal according to the updated call-incoming mode.

For example, in the case where the environment is determined to be in the blocked state by the environment determination unit 270, the notice controller 280 switches the call-incoming mode to the notice vibration mode. In other words, in the case where the call-incoming mode is set to the notice sound mode, when the environment of the mobile phone 100 is surrounded, the notice controller 280 switches the call-incoming mode to the notice vibration mode. In addition, the notice controller 280 is an example of a notice controller disclosed in Claims.

In this manner, the call-incoming mode is switched to the notice vibration mode when the mobile phone 100 may be received in a pocket of user's clothes, so that the mobile phone 100 is surrounded, since it is difficult for the user to hear the notice sound, the incoming call may be easily perceived by the user. In addition, the call-incoming mode is switched to the notice vibration mode when the mobile phone 100 may be received in a bag, so that the mobile phone 100 is surrounded, since it is difficult to immediately take out the mobile phone 100, a problem in that a loud notice sound rings for a long time may be suppressed.

In addition, the notice controller 280 periodically performs an output instruction on the reference signal generation unit 221 to output the reference signal from the speaker unit 222 according to the setting of the environment determination function. The notice controller 280 may perform the reference-signal-output instruction on the reference signal generation unit 221 in units of several tens of seconds or several minutes.

In this manner, due to the provided environment determination unit 270, it may be determined by comparing the blockage threshold value stored in the blockage threshold value storage unit 260 with the measurement signal measured by the detection signal measurement unit 230 whether the mobile phone 100 is in the blocked state or the open state. In other words, due to the provided environment determination unit 270, the environment of the mobile phone 100 may be determined.

In addition, the notice controller 280 is provided, so that the notice controller 280 switches the call-incoming mode based on the result of the determination of the environment determination unit 270. In other words, in the case where the environment of the mobile phone 100 is surrounded, the notice controller 280 switches the call-incoming mode from the notice sound mode to the notice vibration mode. Therefore, the incoming call may be allowed to be easily perceived by the user, and a problem in that a loud notice sound for a long time may raise an unpleasant feeling in other persons may be lessened. Next, a detailed example of the environment determination method using the call-incoming mode switching unit 200 is described with reference to the drawings.

### Example of Detection of Reference Signal by Mobile Phone 100

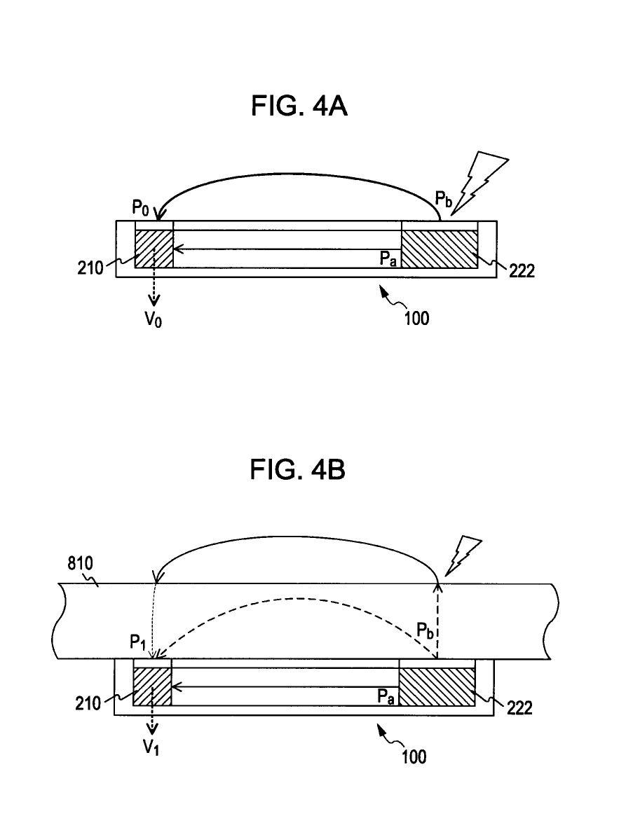

FIGS. 4A and 4B are diagrammatic views illustrating an example of detection of a reference signal by the mobile phone 100 according to the first embodiment of the invention. FIG. 4A is a diagrammatic view illustrating a transmission path of the reference signal in the case where the environment of the mobile phone 100 is in an open state. FIG. 4B is a diagrammatic view illustrating a transmission path of the reference signal in the case where the rear surface of the mobile phone 100 is in a blocked state where the rear surface of the mobile phone 100 is blocked by a shielding object. In FIGS. 4A and 4B, only the sound detection unit 210 and the speaker unit 222 of the mobile phone 100 as viewed from the upper side surface of the mobile phone 100 illustrated in FIG. 1 are diagrammatically illustrated.

In FIG. 4A, an internal sound wave strength (Pₐ), an external sound wave strength (P_{b}), a detection sound wave strength (P₀) of the opened time, and a measurement signal level (V₀) of the opened time are illustrated. The internal sound wave strength (Pₐ) denotes a strength of a sound wave component which propagates an inner portion of the mobile phone 100 among the sound waves as the reference signal output from the speaker unit 222. The external sound wave strength (P_{b}) denotes a strength of a sound wave component which propagates an outer portion of the mobile phone 100 among the sound waves as the reference signal output from the speaker unit 222 of the mobile phone 100.

The detection sound wave strength (P₀) of the opened time denotes a strength of the sound wave collected by the sound detection unit 210 in the case where there is no shielding object on the rear surface of the mobile phone 100. The detection sound wave strength (P₀) of the opened time is a detection sound strength generated by superposition of the component of the external sound wave strength (P_{b}) which is attenuated mainly during the propagation in the air and the internal sound wave strength (Pₐ). The measurement signal level (V₀) of the opened time denotes a level of the measurement signal indicating a magnitude of the detection sound signal when the detection sound wave strength (P₀) of the opened time is detected by the sound detection unit 210.

In FIG. 4B, the internal sound wave strength (Pₐ), the external sound wave strength (P_{b}), a detection sound wave strength (P₁) of the blocked time, and a measurement signal level (V₁) of the blocked time are illustrated. The internal sound wave strength (Pₐ) and the external sound wave strength (P_{b}) are the same as those of FIG. 4A, and thus, the description thereof is omitted.

The detection sound wave strength (P₁) of the blocked time denotes a strength of a sound wave collected by the sound detection unit 210 in the case where the entire rear surface of the mobile phone 100 is blocked by a shielding object 810. The detection sound wave strength (P₁) of the blocked time is generated by superposition of the component of the external sound wave strength (P_{b}) which mainly propagates the shielding object 810, the component of the external sound wave strength (P_{b}) which passes through an outer portion of the shielding object 810, and the internal sound wave strength (Pₐ). Therefore, due to the passing through the shielding object 810, the component of the external sound wave strength (P_{b}) is reflected and attenuated, so that the detection sound wave strength (P₁) of the blocked time is smaller than the detection sound wave strength (P₀) of the opened time.

The measurement signal level (V₁) of the blocked time denotes a level of the measurement signal indicating a magnitude of the detection sound signal when the detection sound wave strength (P₁) of the blocked time is detected by the sound detection unit 210. In other words, the measurement signal level (V₁) of the blocked time is the signal level of the measurement signal corresponding to the detection sound wave strength (P₁) of the blocked time.

In this manner, the rear surface of the mobile phone 100 is blocked by the shielding object 810, so that the magnitude of the detection sound signal supplied from the sound detection unit 210 is varied. Therefore, it is determined based on the change in the detection sound signal whether or not the mobile phone 100 is in the blocked state. Next, an example where the environment of the mobile phone 100 is determined based on the measurement signal level indicating a magnitude of the detection sound signal is described with reference to the drawings.

### Example of Environment Determination Based on Magnitude of Detection Sound Signal

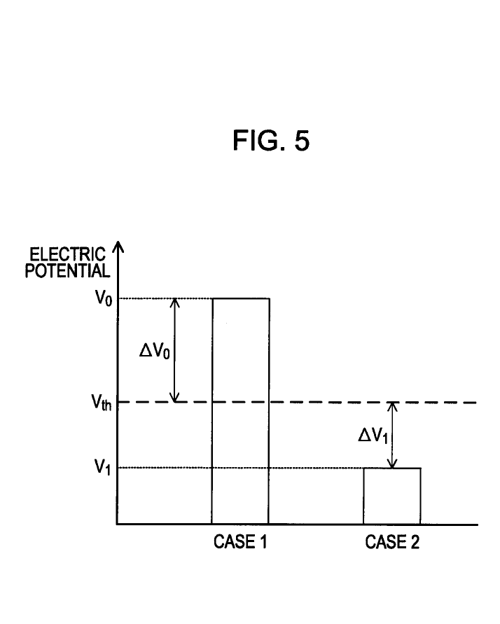

FIG. 5 is a diagram illustrating an example of the environment determination of the mobile phone 100 based on a magnitude of the detection sound signal by the environment determination unit 270 according to the first embodiment of the invention. Herein, the measurement signal levels (V₀ and V₁) illustrated in FIGS. 4A and 4B and the blockage threshold value (Vₜₕ) stored in the blockage threshold value storage unit 260 are illustrated in the vertical axis as electric potentials.

The measurement signal level (V₀) of CASE 1 denotes the measurement signal level in the open state illustrated in FIG. 4A. The measurement signal level (V₀) of CASE 1 denotes the value that is larger than the blockage threshold value (Vₜₕ) by an open level difference (ΔV₀). Therefore, the environment is determined to be in the open state by the environment determination unit 270.

The measurement signal level (V₁) of CASE 2 denotes the measurement signal level in the blocked state illustrated in FIG. 4B. The measurement signal level (V₁) of CASE 2 denotes the value that is smaller than the blockage threshold value (Vₜₕ) by a blockage level difference (AU. Therefore, the environment is determined to be in the blocked state by the environment determination unit 270.

The blockage threshold value (Vₜₕ) is a threshold value that is set to be smaller than the measurement signal level (V₀) of CASE 1. The blockage threshold value (Vₜₕ) is set by considering the environment of the mobile phone 100. For example, in the case where the attenuation amount of the notice sound caused by the shielding object that shields the mobile phone 100 is small, the blockage threshold value (Vₜₕ) is set to a low value.

In this manner, by comparing the measurement signal level (V₀ or V₁) and the blockage threshold value (Vₜₕ), the environment determination unit 270 may determine whether or not the environment of the mobile phone 100 is surrounded. In other words, the environment determination unit 270 may determine the environment of the mobile phone 100 based on the magnitude of the detection sound signal detected by the detection signal measurement unit 230. Therefore, the notice controller 280 may controls the notice sound signal generation unit 151 or the notice vibration signal generation unit 161 to generate the notice sound signal or the notice vibration signal based on the magnitude of the detection sound signal.

In addition, although a configuration where the sound detection unit 210 and the speaker unit 222 are disposed on the same plane is exemplified for the convenience of the description herein, the invention is not limited thereto. In addition, instead of one set of the sound detection unit 210 and the speaker unit 222, a plurality of the sets may be disposed, it may be determined whether or not only a specific side is blocked, and the call-incoming mode may be switched based on the result of the determination.

### Example of Operations of Mobile Phone 100

Next, the operations of the mobile phone 100 according to the first embodiment of the invention are described with reference to the drawings.

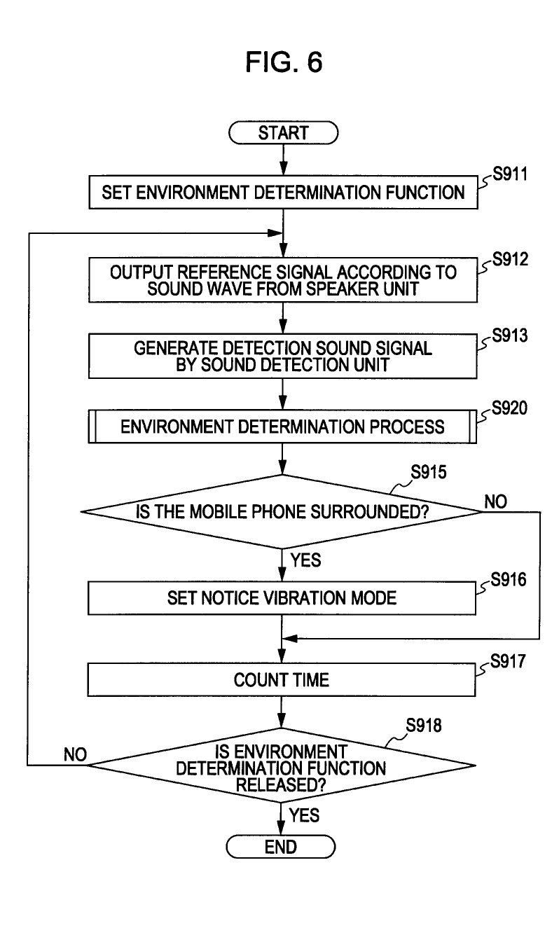

FIG. 6 is a flowchart illustrating an example of a procedure of the notice control method by an environment determination function of the mobile phone 100 according to the first embodiment of the invention.

First, manipulation for setting the environment determination function is received by the manipulation reception unit 180 (Step S911). Next, a sound signal as a reference signal is output from the reference signal output unit 220 according to an instruction from the call-incoming mode switching unit 200 (Step S912). In addition, Step S912 is an example of a reference signal output procedure disclosed in Claims.

Next, the sound signal is detected by the sound detection unit 210, so that a detection sound signal is generated (Step S913). In addition, Step S913 is an example of a reference signal detection procedure disclosed in Claims.

Next, the environment determination process is performed by the environment determination unit 270 based on the detection sound signal generated by the sound detection unit 210 (Step S920). Next, the content of the determination information as the result of the determination of the environment determination unit 270 is determined by the notice controller 280 (Step S915).

Next, in the case where the environment is determined to be in the blocked state by the environment determination unit 270, the notice controller 280 switches the call-incoming mode into the notice vibration mode. (Step S916). In other words, the notice controller 280 controls one notice signal generation unit among a plurality of the notice signal generation units to generate the notice signal based on the detection signal generated by the sound detection unit 210.

On the other hand, in the case where the environment is determined to be in the open state by the environment determination unit 270, the procedure proceeds to the process of Step S917. In addition, Steps S915, S916, and S920 are an example of a notice control procedure disclosed in Claims.

Next, time is measured by the notice controller 280 (Step S917), and after a predetermined time is passed, it is determined whether or not the environment determination function is released (Step S918). Next, in the case where the environment determination function is not released, the procedure returns to Step S912, and a series of processes are repeatedly performed until the environment determination function is released. On the other hand, if the environment determination function is released, the notice control process according to the environment determination function is ended.

### Example of Environment Determination Process by Call-Incoming Mode Switching Unit 200

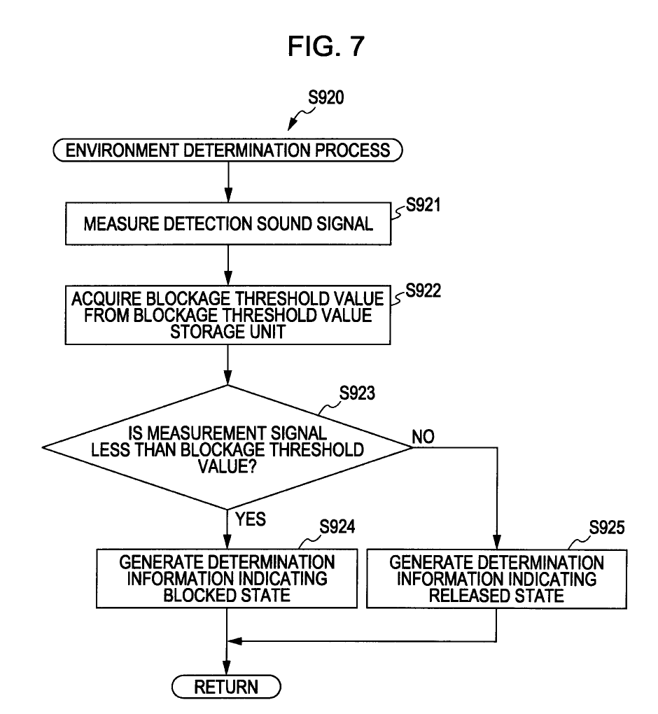

FIG. 7 is a flowchart illustrating an example of a procedure of an environment determination process (Step S920) by the call-incoming mode switching unit 200 according to the first embodiment of the invention.

First, the detection sound signal supplied from the sound detection unit 210 is measured by the detection signal measurement unit 230, so that a measurement signal is generated (Step S921). Subsequently, the environment determination unit 270 determines whether or not the signal level of the measurement signal supplied by the detection signal measurement unit 230 is smaller than a blockage threshold value stored in the blockage threshold value storage unit 260 (Step S922).

Next, in the case where the measurement signal level is smaller than the blockage threshold value, determination information indicating the blocked state as a determination result is generated by the environment determination unit 270 (Step S923). On the other hand, in the case where the measurement signal level is equal to or larger than the blockage threshold value, the determination information indicating the open state as a determination result is generated by the environment determination unit 270 (Step S924). After the generation of the determination information is ended, the operations of the environment determination process are ended.

In this manner, in the first embodiment according to the invention, the sound signal output from the reference signal output unit 220 may be detected by the sound detection unit 210, and it may be determined based on the magnitude of the detection sound signal whether or not the environment of the mobile phone 100 is surrounded. Accordingly, in the case where the environment is determined to be in the blocked state, where the environment of the mobile phone 100 is surrounded, by the environment determination unit 270, the notice controller 280 may set the call-incoming mode to the notice vibration mode.

In addition, herein, in the case where the environment is determined to be in the blocked state by the environment determination unit 270, the example where the call-incoming mode is set to the notice vibration mode is described. However, the call-incoming mode may be set to the notice sound mode, not the notice vibration mode. For example, when the mobile phone 100 is received in a bag, if the call-incoming mode is switched from the notice vibration mode to the notice sound mode, the user may easily perceive the call incoming of the mobile phone 100.

In this case, when the mobile phone 100 is determined to be in the blocked state, the call-incoming mode of the mobile phone 100 is switched to the notice sound mode, so that the incoming call may be easily perceived by the user. At this time, in order to allow the user to easily perceive the incoming call, the sound volume in the notice sound mode may be increased based on the magnitude of the detection sound signal.

In this manner, in the case where the environment is determined to be in the blocked state by the environment determination unit 270, it is selected based on the environment of the mobile phone 100 or user's desire whether the call-incoming mode of the mobile phone 100 is set to the notice sound mode or the notice vibration mode. Therefore, in the case where the environment determination function is set, the call-incoming mode set for the case where the environment is determined to be in the blocked state may be pre-designated by the user.

In addition, in the first embodiment of the invention, an example where the environment of the mobile phone 100 is determined based on the magnitude of the detection sound signal is described. However, in this example, since only the magnitude of the detection sound signal is used as the object of the determination, it is difficult to set the blockage threshold value.

In addition, since the absorbance or reflectance of the shielding object shielding the sound wave as the reference signal is varied according to the frequency of the sound wave, the environment may not be accurately determined based on the reference signal constructed with a single frequency component. For example, if a sound wave having a very low frequency (several tens of Hz is set as the reference signal, in the case where the shielding object is in contact with the mobile phone 100, the shielding object is vibrated, so that the reference signal may be efficiently propagated to the sound detection unit 210.

On the other hand, if a sound wave having a high frequency (several KHz) is set as the reference signal, since the directivity of the sound wave is high, the sound wave may be easily absorbed into the shielding object, and if the shielding object is slightly in contact with the mobile phone 100, the reference signal may hardly be propagated to the sound detection unit 210. On the contrary, in the below-described second embodiment, an improved configuration where a reference signal constructed with a plurality of frequency components is output, and the environment of the mobile phone 100 is determined by analyzing frequency components of a generated detection sound signal based on the reference signal is described.

### 2. Second Embodiment

### Example of Configuration of Call-Incoming Mode Switching Unit

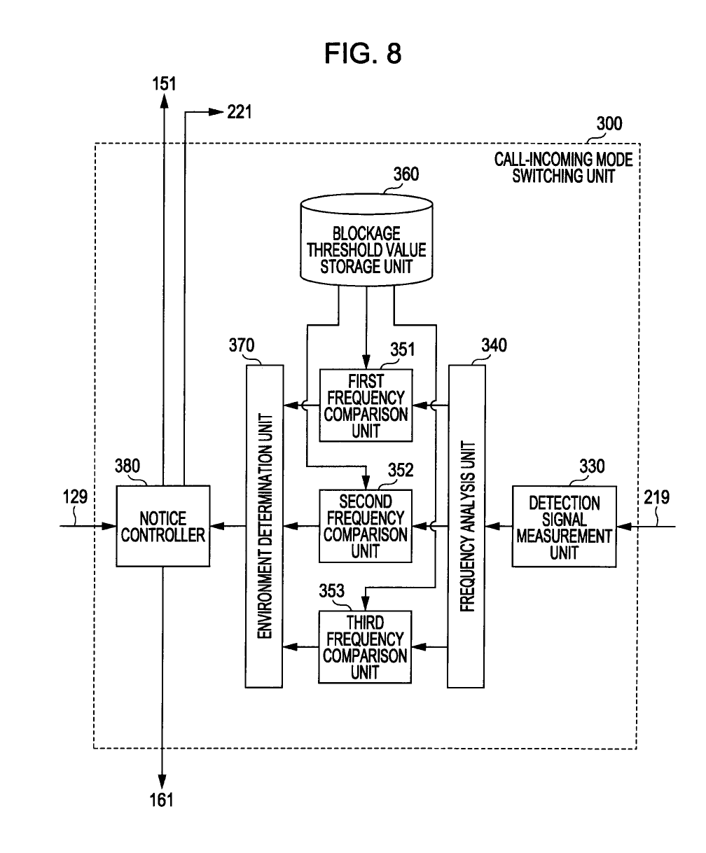

FIG. 8 is a block diagram illustrating an example of a configuration of a call-incoming mode switching unit 300 according to a second embodiment of the invention.

The call-incoming mode switching unit 300 includes a detection signal measurement unit 330, a frequency analysis unit 340, first to third frequency comparison units 351 to 353, a blockage threshold value storage unit 360, an environment determination unit 370, and a notice controller 380. The call-incoming mode switching unit 300 corresponds to the call-incoming mode switching unit 200 illustrated in FIG. 2. In addition, the detection signal measurement unit 330 of the call-incoming mode switching unit 300 is the same as the detection signal measurement unit 230 illustrated in FIG. 3, the description thereof is omitted.

The frequency analysis unit 340 is used to analyze the measurement signal supplied from the detection signal measurement unit 330. The frequency analysis unit 340 generates the frequency components of the measurement signal by converting the measurement signal supplied from the detection signal measurement unit 330 from a time area to a frequency area. The frequency analysis unit 340 calculates a distribution of the frequency components of the measurement signal by using, for example, a fast Fourier transform (FFT).

In addition, the frequency analysis unit 340 supplies the values of the powers of the frequency components corresponding to the predetermined first to third frequencies among the calculated frequency components as the first to third frequency levels to the first to third frequency comparison units 351 to 353. In other words, the frequency analysis unit 340 supplies the first frequency level to the first frequency comparison unit 351, supplies the second frequency level to the second frequency comparison unit 352, and supplies the third frequency level to the third frequency comparison unit 353.

For example, the frequency analysis unit 340 supplies the values of the powers of the components corresponding to the frequencies other than the voice band among the frequency components of the measurement signal as the first to third frequency levels to the first to third frequency comparison units 351 to 353.

The first to third frequency comparison units 351 to 353 compares the first to third frequency levels supplied from the frequency analysis unit 340 and the first to third blockage threshold values stored in the blockage threshold value storage unit 360.

The first frequency comparison unit 351 compares the first frequency level and the first blockage threshold value and supplies the comparison result as a first comparison result to the environment determination unit 370. For example, in the case where the first frequency level is equal to or larger than the first blockage threshold value, the first frequency comparison unit 351 outputs the H (high) level as the first comparison result to the environment determination unit 370. In the case where the first frequency level is smaller than the first blockage threshold value, the first frequency comparison unit 351 outputs the L (low) level as the first comparison result to the environment determination unit 370.

The second frequency comparison unit 352 compares the second frequency level and the second blockage threshold value and supplies the comparison result as a second comparison result to the environment determination unit 370. For example, in the case where the second frequency level is equal to or larger than the second blockage threshold value, the second frequency comparison unit 352 supplies the H level as the second comparison result to the environment determination unit 370. In the case where the second frequency level is smaller than second blockage threshold value, the second frequency comparison unit 352 supplies the L level as the second comparison result to the environment determination unit 370.

The third frequency comparison unit 353 compares the third frequency level and the third blockage threshold value and supplies the comparison result as a third comparison result to the environment determination unit 370. For example, in the case where the third frequency level is equal to or larger than the third blockage threshold value, third frequency comparison unit 353 supplies the H level as the third comparison result to the environment determination unit 370. In the case where the third frequency level is smaller than third blockage threshold value, the third frequency comparison unit 353 supplies the L level as the third comparison result to the environment determination unit 370.

The blockage threshold value storage unit 360 stores the first to third blockage threshold values corresponding to the first to third frequency components of the measurement signal. The blockage threshold value storage unit 360 outputs the first blockage threshold value to the first frequency comparison unit 351, outputs the second blockage threshold value to the second frequency comparison unit 352, and outputs the third blockage threshold value to the third frequency comparison unit 353.

The environment determination unit 370 determines based on the first to third comparison results supplied from the first to third frequency comparison units 351 to 353 whether or not the environment of the mobile phone 100 is surrounded. For example, in the case where the all the first to third comparison results are the L level, the environment determination unit 370 determines the environment to be in the blocked state, where the environment of the mobile phone 100 is surrounded.

On the other hand, in the case where at least one comparison result among the first to third comparison results is the H level, the environment determination unit 370 determines the environment to be in the open state, where the environment of the mobile phone 100 is not surrounded. As another example, in the case where at least one comparison result among the first to third comparison results is the L level, the environment determination unit 370 may determine the environment to be in the blocked state; and in the other case, the environment determination unit 370 may determine the environment to be in the open state.

In addition, the environment determination unit 370 supplies the result of the determination to the notice controller 380. As an example of the result of the determination, in the case where the environment is determined to be in the blocked state, the environment determination unit 370 generates the determination information indicating the blocked state. In the case where the environment is determined to be in the open state, the environment determination unit 370 generates the determination information indicating the open state. In addition, the environment determination unit 370 supplies the generated determination information to the notice controller 380.

In the case where the incoming call signal is supplied from the control line 129, the notice controller 380 allows one of the notice sound signal generation unit 151 and the notice vibration signal generation unit 161 to generate the notice signal according to the call-incoming mode determined by the result of the determination of the environment determination unit 370. In other words, the notice controller 380 controls one notice signal generation unit among a plurality of the notice signal generation units to generate the notice signal based on the frequency components of the detection sound signal generated by the sound detection unit 210. In addition, since the other functions of the notice controller 380 are the same as those of the notice controller 280, the description thereof is omitted.

In this manner, the call-incoming mode switching unit 300 may determine the environment of the mobile phone 100 based on the frequency components generated by the frequency analysis unit 340 and the blockage threshold values corresponding to the frequency components. In addition, although an example where the environment of the mobile phone 100 is determined based on the three frequency components among the frequency components of the measurement signal by the first to third frequency comparison units 351 to 353 is described herein, the invention is not limited thereto. Next, a detailed example of the environment determination method of the call-incoming mode switching unit 300 is described with reference to the drawings.

### Example of Environment Determination Based on Frequency Component of Measurement Signal

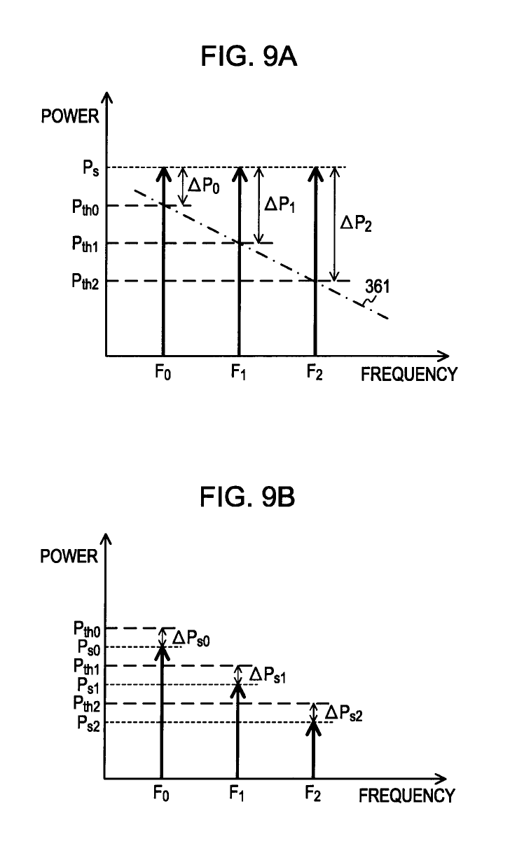

FIGS. 9A and 9B are diagrams illustrating an example of environment determination based on a frequency component of a measurement signal by the call-incoming mode switching unit 300 according to the second embodiment of the invention.

FIG. 9A illustrates frequency components corresponding to the first to third frequencies (F₀ to F₂) among the frequency components of the measurement signal in the open state illustrated in FIG. 4A. FIG. 9B illustrates frequency components corresponding to the first to third frequencies (F₀ to F₂) among the frequency components of the measurement signal in the blocked state illustrated in FIG. 4B.

In this example, it is assumed that a sound signal that is the reference signal constructed with the first to third frequency components (F₀ to F₂) having the same level is output by the reference signal output unit 220. Herein, the vertical axis is a power, and the horizontal axis is a frequency.

In FIG. 9A, first to third frequency levels (Pₛ) in the open state, a blockage threshold value characteristic 361, and first to third blockage threshold values (Pₜₕ₀ to Pₜₕ₂) are illustrated.

The first to third frequency levels (Pₛ) in the open state denote the values of the powers of the frequency components corresponding to the first to third frequencies (F₀ to F₂) among the frequency components of the measurement signal in the open state illustrated in FIG. 4A. Since the first to third frequency levels (Pₛ) in the open state have no absorbance caused by a shielding object, all the first to third frequency levels (Pₛ) in the open state are expressed as the same level.

The first frequency level (Pₛ) in the open state is larger than the first blockage threshold value (Pₜₕ₀) by a first exceeding level difference (P₀). In addition, the second frequency level (Pₛ) in the open state is larger than the second blockage threshold value (Pₜₕ₁) by a second exceeding level difference (P₁). In addition, the third frequency level (Pₛ) in the open state is larger than the third blockage threshold value (Pₜₕ₂) by a third exceeding level difference (P₃).

The blockage threshold value characteristic 361 is a frequency characteristic of the blockage threshold value used to determine whether or not the mobile phone 100 is in the blocked state. The blockage threshold value characteristic 361 is determined by considering the propagation characteristics of the sound signal in the shielding object which shields the environment of the mobile phone 100. In this example, since the absorption amount of the sound wave in the shielding object is increased in proportion to the frequency of the sound wave, the blockage threshold value characteristic 361 is determined by considering the attenuation characteristics of the sound wave.

The first to third blockage threshold values (Pₜₕ₀ to Pₜₕ₂) are threshold values which are set based on the blockage threshold value characteristic 361. In other words, the first blockage threshold value (Pₜₕ₀) is a blockage threshold value corresponding to the first frequency (F₀). The second blockage threshold value (Pₜₕ₁) is a blockage threshold value corresponding to the second frequency (F₁). The third blockage threshold value (Pₜₕ₂) is a blockage threshold value corresponding to the third frequency (F₂). In addition, as blockage threshold value data stored in the blockage threshold value storage unit 360, a slope of the blockage threshold value characteristic 361 may be stored instead of the first to third blockage threshold values.

In this case, since all the first to third frequency levels (Pₛ) in the open state are equal to or larger than the corresponding first to third blockage threshold values (Ptho to Pₜₕ₂), the environment is determined to be in the open state by the environment determination unit 370. In other words, since all the first to third frequency comparison units 351 to 353 output the H level, the environment is determined to be in the open state by the environment determination unit 370.

In FIG. 9B, first to third frequency levels (Pₛ₀ to Pₛ₂) in the blocked state and first to third blockage threshold values (Pₜₕ₀ to Pₜₕ₂) are illustrated. In addition, the first to third blockage threshold values (Pₜₕ₀ to Pₜₕ₂) are the same as those of FIG. 9A.

The first to third frequency levels (Pₛ₀ to Pₛ₂) in the blocked state denote the values of the powers of the frequency components corresponding to the first to third frequencies (Fₒ to F₂) among the frequency components of the measurement signal in the blocked state illustrated in FIG. 4B. The first frequency level (Pₛ₀) in the blocked state is smaller than the first blockage threshold value (Pₜₕ₀) by a first attenuated level difference (ΔPₛ₀).

In addition, the second frequency level (Pₛ₁) in the blocked state is smaller than the second blockage threshold value (Pₜₕ₁) by a second attenuated level difference (ΔPₛ₁). In addition, the third frequency level (Pₛ₂) in the blocked state is smaller than the third blockage threshold value (Pₜₕ₂) by a third attenuated level difference (ΔPₛ₂).

In this case, since all the first to third frequency levels (Pₛ₀ to Pₛ₂) in the blocked state are smaller than the corresponding first to third blockage threshold values (Pₜₕ₀ to Pₜₕ₂), the environment is determined to be in the blocked state by the environment determination unit 370. In other words, since all the first to third frequency comparison units 351 to 353 output the L level, the environment is determined to be in the blocked state by the environment determination unit 370.

In this manner, by comparing the frequency components (F₀ to F₂) of the measurement signal and the corresponding first to third blockage threshold values (Pₜₕ₀ to Pₜₕ₂), the environment determination unit 370 may determine whether or not the environment of the mobile phone 100 is surrounded. In other words, the environment determination unit 370 may determine the environment of the mobile phone 100 based on the frequency components of the detection sound signal. Therefore, unlike the environment determination unit 270 according to the first embodiment, since the environment is determined based on a plurality of the comparison results, the erroneous determination of the environment determination unit 370 may be reduced.

In addition, a sound signal constructed with predetermined frequency components (F₀ to F₂) is output by the reference signal output unit 220, and the notice controller 380 may set the call-incoming mode based on the predetermined frequency components (F₀ to F₂) of a sound detection signal generated from the sound signal. Therefore, since noise components that are different frequency components included in the detection sound signal are removed, the notice controller 380 instructs the notice sound signal generation unit 151 or the notice vibration signal generation unit 161 to generate the notice signal based on the determination result that is more accurate than those of the environment determination unit 270.

In addition, it is preferable that the first to third frequency components (F₀ to F₂) in the reference signal output from the speaker unit 222 are the frequency components outside the human audible voice band. For example, the first frequency (F₀) may be set to be equal to or smaller than 100 Hz, and the second and third frequencies (F₁ to F₂) may be set to be in a range of 15 KHz to 20 KHz. Next, the operations of the call-incoming mode switching unit 300 are described with reference to the drawings.

### Example of Environment Determination Process by Call-Incoming Mode Switching Unit 300

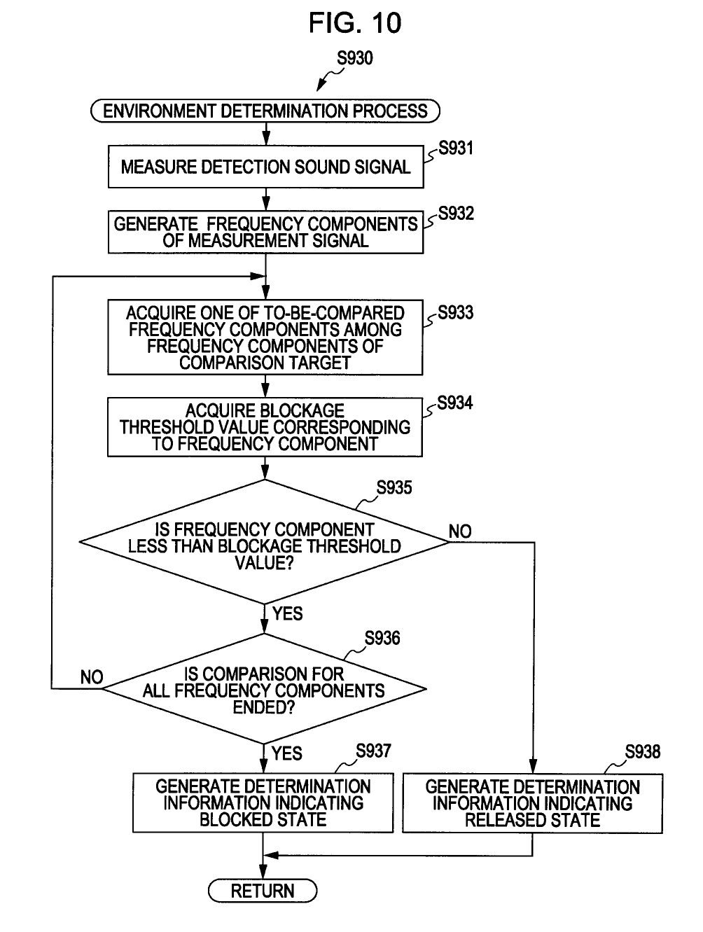

FIG. 10 is a flowchart illustrating an example of a procedure of an environment determination process (Step S930) by a call-incoming mode switching unit 300 according to the second embodiment of the invention. The environment determination process (Step S930) corresponds to the environment determination process (Step S920) illustrated in FIG. 6. In the example, it is assumed that, when all the comparison results are at L level, the environment is determined to be in the blocked state by the environment determination unit 370.

First, the detection sound signal is measured by the detection signal measurement unit 330, so that the measurement signal is generated (Step S931). Next, the frequency components of the measurement signal supplied from the detection signal measurement unit 330 are generated by the frequency analysis unit 340 (Step S932). In other words, the frequency levels indicating the values of the powers of the frequency components are calculated by the frequency analysis unit 340.

Next, the first frequency level from the frequency analysis unit 340 is acquired by the first frequency comparison unit 351 (Step S933). In addition, the first blockage threshold value corresponding to the first frequency level among the blockage threshold values stored in the blockage threshold value storage unit 360 is acquired (Step S934). Next, in the first frequency comparison unit 351, it is determined whether or not the first frequency level is smaller than the first blockage threshold value (Step S935).

Next, in the case where the first frequency level is smaller than the first blockage value, since the L level as the first comparison result is output from the first frequency comparison unit 351, the determination information indicating the open state is generated by the environment determination unit 370 (Step S936). On the other hand, in the case where the first frequency level is equal to or larger than the first blockage value, the environment determination unit 370 determines whether or not all the comparison results for the frequency components as the comparison objects are acquired from the first to third frequency comparison units 351 to 353 (Step S936).

Next, in the case where all the comparison results are acquired, the determination information indicating the blocked state is generated by the environment determination unit 370 (Step S935). On the other hand, in the case where all the comparison results are not acquired, the procedure returns to Step S932, and the second frequency level and the corresponding second blockage threshold value are acquired and compared by the second frequency comparison unit 352.

In this manner, until the frequency levels as the comparison objects are equal to or larger than the blockage threshold values corresponding to the frequency levels, all the comparisons of the first to third frequency comparison units 351 to 353 are sequentially performed. Next, in the case where all the frequency levels of the frequency components as the comparison objects are smaller than the corresponding blockage threshold values, the determination information indicating the blocked state is generated. In the other cases, the determination information indicating the open state is generated, and the environment determination process is ended.

In this manner, in the second embodiment of the invention, it is possible to determine based on the frequency components of the measurement signal generated from the detection sound signal of the sound detection unit 210 whether or not the environment of the mobile phone 100 is surrounded. In other words, the call-incoming mode switching unit 300 may determine based on the frequency components of the detection sound signal whether or not the environment is in the blocked state.

In addition, in the first and second embodiments of the invention, an example where the reference signal is output from the speaker unit 222 is described. However, the reference signal may be generated by vibrating the mobile phone 100 by using the vibration generation unit 162. Hereinafter, an example where the reference signal is generated by vibrating the mobile phone is described with reference to the drawings.

### 3. Third Embodiment

### Example of Outer Appearance of Mobile Phone

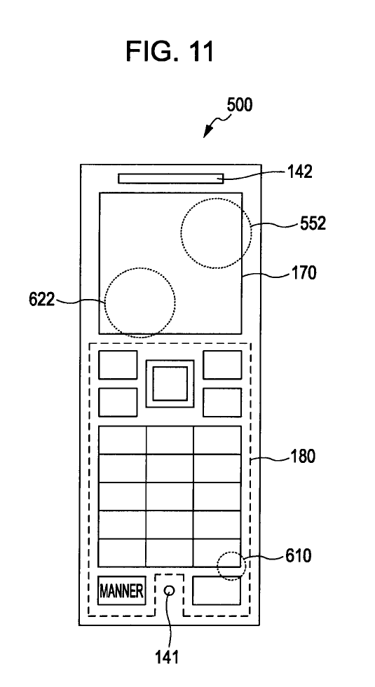

FIG. 11 is an outer appearance view illustrating an outer appearance of a mobile phone according to a third embodiment of the invention. Herein, as an outer appearance of the front surface of a mobile phone 500, a speaker unit 552, a vibration detection unit 610, and a vibration generation unit 622 instead of the vibration generation unit 162, the sound detection unit 210, and the speaker unit 222 of the mobile phone 100 illustrated in FIG. 1 are illustrated. Since the other components are the same as those illustrated in FIG. 1, the other components are denoted by the same reference numerals as those of FIG. 1, and the description thereof is omitted.

The speaker unit 552 is a speaker for outputting a notice sound for notifying the user of the call incoming when a phone call or a mail is received from a communication counterparty. The speaker unit 552 outputs the notice sound pre-designated by the user among a plurality of the notice sound signals at the call incoming time.

The vibration generation unit 622 is a motor for generating the notice vibration for notifying the user of the call incoming by using vibration. The vibration generation unit 622 generates the notice vibration pre-designated by the user among a plurality of the notice vibrations at the call incoming time.

In addition, the vibration generation unit 622 vibrates the mobile phone 500 by generating the reference signal for determining the environment situation of the mobile phone 500. In addition, for example, when an internal clock of the mobile phone 500 is at a pre-designated time, vibration generation unit 622 generates an alarm vibration.

The vibration detection unit 610 is a sensor for detecting a reference signal generated by the vibration generation unit 622 so as to determine the environment situation of the mobile phone 500 in the case where the environment determination function is set.

In this manner, with respect to the mobile phone 500, in the case where the environment determination function is set, the vibration detection unit 610 detects the vibration of the mobile phone 500 based on the reference signal generated by the vibration generation unit 622, so that the call-incoming mode of the mobile phone 500 is switched. Next, the configuration of the mobile phone 500 is described in detail with reference to the drawings.

### Example of Configuration of Mobile Phone 500

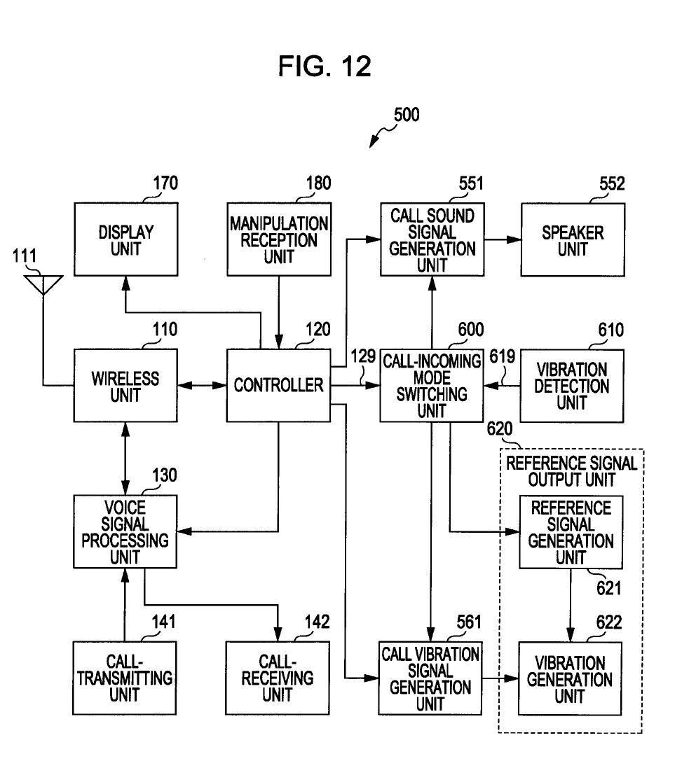

FIG. 12 is a block diagram illustrating an example of a configuration of the mobile phone 500 according to the third embodiment of the invention.

The mobile phone 500 includes a notice sound signal generation unit 551, a speaker unit 552, and a notice vibration signal generation unit 561 instead of the notice sound signal generation unit 151, the notice vibration signal generation unit 161, and the vibration generation unit 162 of the mobile phone 100 illustrated in FIG. 2. In addition, the mobile phone 500 includes a call-incoming mode switching unit 600, a vibration detection unit 610, and a reference signal output unit 620 instead of the call-incoming mode switching unit 200, the sound detection unit 210, and the reference signal output unit 220 of the mobile phone 100 illustrated in FIG. 2.

Herein, since the components other than the notice sound signal generation unit 551, the speaker unit 552, the notice vibration signal generation unit 561, the call-incoming mode switching unit 600, the vibration detection unit 610, and the reference signal output unit 620 are the same as those of FIG. 2, the components are denoted by the same reference numerals as those of FIG. 2, and the description thereof is omitted.

The notice sound signal generation unit 551 generates a notice sound signal as a notice signal based on a notice sound setting parameter supplied from the controller 120 according to an instruction of the call-incoming mode switching unit 600. In other words, in the case where the call-incoming mode in the call-incoming mode switching unit 600 is set to a notice sound mode, the notice sound signal generation unit 551 generates the notice sound signal based on the notice sound setting parameter so as to notify the user of the call incoming by using a sound wave. The notice sound signal generation unit 551 supplies the generated notice sound signal to the speaker unit 552. In addition, the notice sound signal generation unit 551 is an example of a notice signal generation unit disclosed in Claims.

The speaker unit 552 is a speaker for outputting the notice sound based on the notice sound signal generated by the notice sound signal generation unit 551. In other words, in the case where the call-incoming mode is set to the notice sound mode in the call-incoming mode switching unit 600, when there is call incoming, the speaker unit 552 outputs the notice sound signal as a sound wave.

The notice vibration signal generation unit 561 generates a notice vibration signal as a notice signal based on a notice vibration setting parameter supplied from the controller 120 according to an instruction of the call-incoming mode switching unit 600. In other words, in the case where the call-incoming mode in the call-incoming mode switching unit 600 is set to a notice vibration mode, the notice vibration signal generation unit 561 generates the notice vibration signal based on the notice vibration setting parameter so as to notify the user of the call incoming by using vibration. In addition, the notice vibration signal generation unit 561 supplies the generated notice vibration signal to the vibration generation unit 622. In addition, the notice vibration signal generation unit 561 is an example of a notice signal generation unit disclosed in Claims.

In the case where the environment determination function is set, the call-incoming mode switching unit 600 determines the environment situation of the mobile phone 500 based on the detection vibration signal supplied from the vibration detection unit 610 and switches the call-incoming mode according to the result of the determination. In other words, in the case where the environment determination function is set, when the incoming call signal is supplied from the controller 120, the call-incoming mode switching unit 600 notifies the user that there is an incoming call according to the call-incoming mode switched based on the detection vibration signal.

In addition, in the case where the environment determination function is set, the call-incoming mode switching unit 600 controls one of the notice sound signal generation unit 551 and the notice vibration signal generation unit 561 to generate the notice signal, for example, based on a magnitude of the detection vibration signal. In this case, the call-incoming mode switching unit 600 controls one of the notice sound signal generation unit 551 and the notice vibration signal generation unit 561 to generate the notice sound signal or the notice vibration signal, for example, based on the frequency component of the detection vibration signal.

In addition, in the case where the environment determination function is set, when the incoming call signal is supplied from the controller 120, the call-incoming mode switching unit 600 instructs one of the notice sound signal generation unit 551 and the notice vibration signal generation unit 561 to generate the notice signal. In addition, in the case where the environment determination function is set, the call-incoming mode switching unit 600 switches the call-incoming mode, for example, based on the detection vibration signal and, at the same time, changes the setting parameter in the switched call-incoming mode based on the detection vibration signal.

In addition, in the case where the environment determination function is set, the call-incoming mode switching unit 600 instructs the reference signal generation unit 621 to generate a signal for generating the reference signal from the vibration generation unit 622. In this case, the call-incoming mode switching unit 600 instructs the reference signal generation unit 621 to generate the signal for generating the reference signal from the vibration generation unit 622, for example, in a predetermined time interval.

The vibration detection unit 610 is a sensor for detecting the reference signal generated from the vibration generation unit 622 so as to determine the environment situation of the mobile phone 500 as described with reference to FIG. 11. In other words, the vibration detection unit 610 detects the reference signal output from the reference signal output unit 620. The vibration detection unit 610 generates the detection vibration signal that is a detection signal by converting the detected vibration into an electric signal.

The vibration detection unit 610 is constructed with, for example, a displacement sensor, a velocity sensor, an acceleration sensor, or the like. In addition, the vibration detection unit 610 supplies the generated detection vibration signal through the detection signal line 219 to the call-incoming mode switching unit 600. In addition, an example of the vibration detection unit 610, a sensor having two or more axes may be used instead of a sensor having a single axis. In addition, the vibration detection unit 610 is an example of a reference signal detection unit disclosed in Claims.

The reference signal output unit 620 is used to output the reference signal for determining the environment situation of the mobile phone 500. In other words, the reference signal output unit 620 vibrates the mobile phone 500 by generating the reference signal for determining the environment situation of the mobile phone 500. For example, the reference signal output unit 620 outputs a reference signal of which vibration is smaller than the strength of the notice vibration generated from the notice vibration signal. Therefore, the user may not easily perceive the vibration corresponding to the reference signal, and the user's misunderstanding of the vibration corresponding to the reference signal as the notice vibration corresponding to the incoming call may be reduced. In addition, the reference signal output unit 620 is an example of a reference signal output unit disclosed in Claims.

The reference signal generation unit 621 is used to generate the signal for outputting the reference signal from the vibration generation unit 622. The reference signal generation unit 621 generates the signal for the generating the reference signal from the vibration generation unit 622 according to an instruction from the call-incoming mode switching unit 600. The reference signal generation unit 621 generates the signal for generating the reference signal from the vibration generation unit 622 in a predetermined time interval, for example, according to an instruction from the call-incoming mode switching unit 600. In addition, the reference signal generation unit 621 supplies the signal for outputting the reference signal from the vibration generation unit 622 to the vibration generation unit 622.

The vibration generation unit 622 is a motor of generating vibration as the reference signal based on a signal supplied from reference signal generation unit 621. The vibration generation unit 622 vibrates the mobile phone 500 by generating the reference signal in a predetermined time interval. In addition, the vibration generation unit 622 generates the notice vibration based on the notice vibration signal generated by the notice vibration signal generation unit 561.

In this manner, due to the vibration detection unit 610 and the reference signal output unit 620, the call-incoming mode switching unit 600 may determine the environment of the mobile phone 500 based on the detection vibration signal supplied from the vibration detection unit 610. Accordingly, the call-incoming mode switching unit 600 may switch the call-incoming mode according to the result of the determination. Next, an example of the configuration of the call-incoming mode switching unit 600 is described in detail with reference to the drawings.

### Example of Configuration of Call-Incoming Mode Switching Unit 600

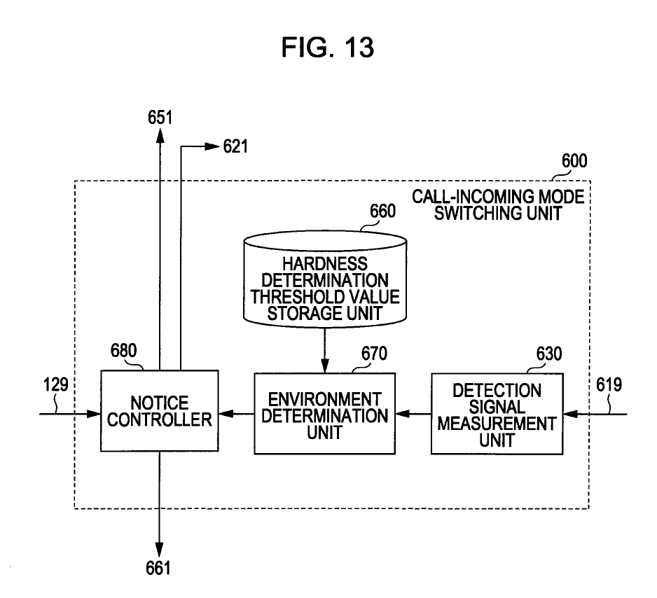

FIG. 13 is a diagram illustrating an example of the configuration of the call-incoming mode switching unit 600 according to the third embodiment of the invention. Herein, it is assumed that the environment determination function is set by the user.

The call-incoming mode switching unit 600 includes a detection signal measurement unit 630, a hardness determination threshold value storage unit 660, an environment determination unit 670, and a notice controller 680.

The detection signal measurement unit 630 is used to measure a magnitude of the detection vibration signal supplied through the detection signal line 619 to the vibration detection unit 610. In other words, the detection signal measurement unit 630 measures the strength of the vibration of the reference signal by a predetermined unit. In addition, the detection signal measurement unit 630 supplies the measured detection vibration signal as the measurement signal to the environment determination unit 670. The detection signal measurement unit 630 supplies, for example, a voltage signal to the environment determination unit 670.

The hardness determination threshold value storage unit 660 stores a hardness determination threshold value used to determine whether or not the contact material being in contact with the mobile phone 500 is hard. The hardness determination threshold value storage unit 660 outputs the stored hardness determination threshold value to the environment determination unit 670.

The environment determination unit 670 determines based on the signal level of the measurement signal supplied from the detection signal measurement unit 630 and the hardness determination threshold value stored in the hardness determination threshold value storage unit 660 whether the contact material for the mobile phone 500 is hard or soft. For example, in the case where the signal level of the measurement signal from the detection signal measurement unit 630 is equal to or larger than the hardness determination threshold value, the environment determination unit 670 determines that the contact material being in contact with the mobile phone 500 is hard. On the other hand, in the case where the signal level of the measurement signal from the detection signal measurement unit 630 is smaller than the hardness determination threshold value, the environment determination unit 670 determines that the contact material being in contact with the mobile phone 500 is soft.

In addition, the environment determination unit 670 supplies the result of the determination to the notice controller 680. As an example of the result of the determination, in the case where the contact material is determined to be hard, the environment determination unit 670 generates determination information indicating that the contact material is hard. In the case where the contact material is determined not to be hard, the environment determination unit 670 generates determination information indicating that the contact material is soft. Next, the environment determination unit 670 supplies the generated determination information as the result of the determination to the notice controller 680.

When the incoming call signal is supplied from the control line 129, the notice controller 680 allows one of the notice sound signal generation unit 551 and the notice vibration signal generation unit 561 to generate the notice signal based on the result of the determination of the environment determination unit 670. In other words, the notice controller 680 controls one notice signal generation unit among a plurality of the notice signal generation units to generate the notice signal based on a magnitude of the detection vibration signal generated by the vibration detection unit 610.

The notice controller 680 updates the call-incoming mode based on the result of the determination by the environment determination unit 670. Next, when the incoming call signal is supplied from the controller 120, the notice controller 680 instructs one of the notice sound signal generation unit 551 and the notice vibration signal generation unit 561 to generate the notice signal according to the updated call-incoming mode from the controller 120.

For example, in the case where the contact material is determined to be hard by the environment determination unit 670, the notice controller 680 switches the call-incoming mode to the notice sound mode. In other words, in the case where the call-incoming mode is set to the notice vibration mode, when the contact material for the mobile phone 500 is hard, the notice controller 680 switches the call-incoming mode to the notice sound mode.

In this manner, the call-incoming mode is switched to the notice sound mode, so that, in the case where the mobile phone 500 is put on a hard material, occurrence of a loud sound between the mobile phone 500 and the contact material caused by the notice vibration may be suppressed. In other words, when the contact material for the mobile phone 500 is determined to be hard by the environment determination unit 670, the call-incoming mode is switched from the notice vibration mode to the notice sound mode, so that occurrence of an unpleasant sound may be suppressed.

In addition, the notice controller 680 periodically performs an output instruction on the reference signal generation unit 621 to output the reference signal from the vibration generation unit 622 according to the setting of the environment determination function. The notice controller 680 may perform the reference-signal-output instruction on the reference signal generation unit 621 in units of several tens of seconds or several minutes. In addition, the notice controller 680 is an example of a notice controller disclosed in Claims.

In this manner, due to the provided environment determination unit 670, it may be determined by comparing the hardness determination threshold value stored in the hardness determination threshold value storage unit 660 with the level of the measurement signal measured by the detection signal measurement unit 630 whether the contact material for the mobile phone 500 is hard or soft. In other words, due to the provided environment determination unit 670, the environment of the mobile phone 500 may be determined.

In addition, although one set of the vibration detection unit 610 and the vibration generation unit 622 is exemplified herein, a plurality of sets of the vibration detection unit 610 and the vibration generation unit 622 may be provided so as to determine the environment of the mobile phone 500. Next, a detailed example of an environment determination method using the call-incoming mode switching unit 600 is described with reference to the drawings.

### Example of Detection of Vibration of Mobile Phone 500 Based on Reference Signal

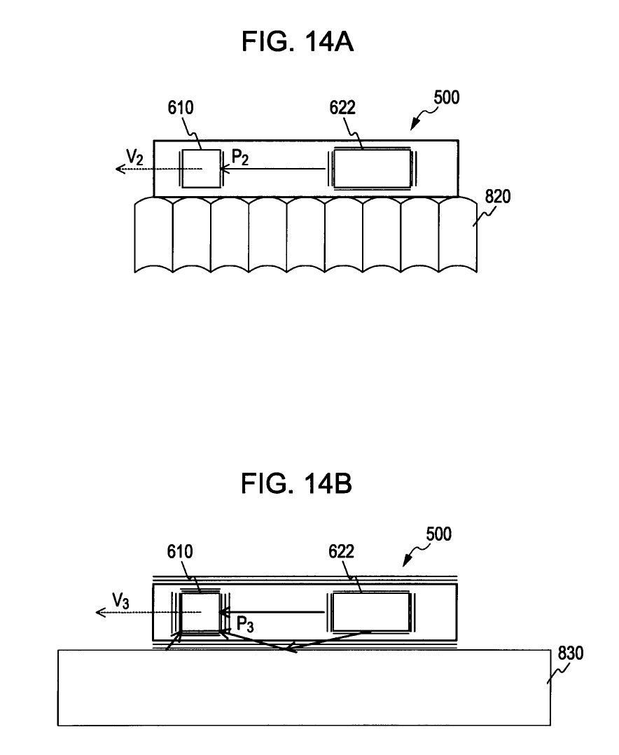

FIGS. 14A and 14B are diagrammatic views illustrating an example of detection of vibration of the mobile phone 500 based on a reference signal by the mobile phone 500 according to the third embodiment of the invention. FIG. 14A is a diagrammatic view illustrating a vibration state of the mobile phone 500 in the case where the contact material for the mobile phone 500 is soft. FIG. 14B is a diagrammatic view illustrating a vibration state of the mobile phone 500 in the case where the contact material for the mobile phone 500 is hard. In FIGS. 14A and 14B, only the vibration detection unit 610 and the vibration generation unit 622 inside the mobile phone 500 as viewed from the upper side surface of the mobile phone 500 illustrated in FIG. 11 are diagrammatically illustrated.

In FIG. 14A, a vibration strength (P₂) for a soft contact material and a measurement signal level (V₂) for the soft contact material are diagrammatically illustrated.

The vibration strength (P₂) for the soft contact material denotes a strength of vibration detected by the vibration detection unit 610 when the vibration generated by the vibration generation unit 622 propagates through the mobile phone 500. Herein, since the vibration generated by the vibration generation unit 622 is attenuated by the soft contact material 820, the vibration strength (P₂) for the soft contact material is smaller than the vibration generated by the vibration generation unit 622.

The measurement signal level (V₂) for the soft contact material denotes a magnitude of a detection vibration signal generated according to the vibration strength (P₂) detected by the vibration detection unit 610.

In FIG. 14B, the detection vibration strength (P₃) for the hard contact material and the measurement signal level (V₃) for the hard contact material are illustrated.

The vibration strength (P₂) for the hard contact material denotes a strength of vibration detected by the vibration detection unit 610 when the vibration generated by the vibration generation unit 622 propagates through the mobile phone 500. Herein, the vibration of the mobile phone 500 is amplified by resonance or the like between the mobile phone 500 which is vibrated by the vibration generation unit 622 and the hard contact material 830. Therefore, the vibration strength (P₂) for the hard contact material is increased in proportion to the vibration generated by the vibration generation unit 622.

The measurement signal level (V₃) for the hard contact material denotes a magnitude of the detection vibration signal generated according to the vibration strength (P₃) detected by the vibration detection unit 610.

In this manner, in the mobile phone 500 which is vibrated according to the reference signal generated by the vibration generation unit 622, the strength of the vibration is varied according to the hardness of the contact material. Therefore, since the magnitude of the detection vibration signal generated by the vibration detection unit 610 is varied, it may be determined based on the variation of the detection vibration signal whether the contact material for the mobile phone 500 is hard or soft. Hereinafter, an example where the environment of the mobile phone 500 is determined based on the measurement signal level indicating a magnitude of the detection vibration signal is described with reference to the drawings.

### Example of Environment Determination Based on Magnitude of Detection Vibration Signal

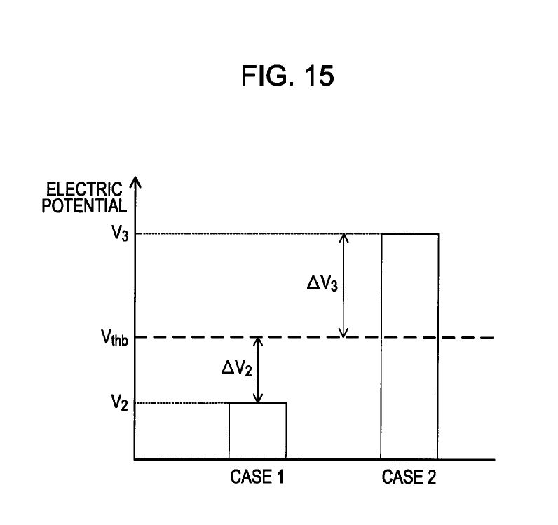

FIG. 15 is a diagram illustrating an example of the environment determination of the mobile phone 500 based on a magnitude of a detection vibration signal by the environment determination unit 670 according to the third embodiment of the invention. Herein, the hardness determination threshold value (V_{thb}) and the measurement signal levels (V₂ and V₃) are illustrated in the vertical axis as electric potentials. In this example, it is assumed that the hardness determination threshold value (V_{thb}) is set to a measurement signal level measured by the detection signal measurement unit 630 in the case where the mobile phone 500 is not in contact with an object.

The measurement signal level (V₂) of CASE 1 denotes the magnitude of the detection sound signal measured by the detection signal measurement unit 630 in the state illustrated in FIG. 14A. The measurement signal level (V₂) of CASE 1 denotes the value that is smaller than the hardness determination threshold value (V_{thb}) by a decreased level difference (ΔV₂). Therefore, the contact material for the mobile phone 500 is determined to be soft by the environment determination unit 670.

The measurement signal level (V₃) of CASE 2 denotes the magnitude of the detection sound signal detected by the detection signal measurement unit 630 in the state illustrated in FIG. 14B. The measurement signal level (V₃) of CASE 2 denotes the value that is larger than the blockage threshold value (V_{thb}) by an increased level difference (ΔV₃). Therefore, the contact material for the mobile phone 500 is determined to be hard by the environment determination unit 670.

In this manner, by comparing the measurement signal level (V₂ or V₃) and the hardness determination threshold value (V_{thb}), the environment determination unit 670 may determine whether or not the contact material for the mobile phone 500 is hard. In other words, the environment of the mobile phone 500 may be determined based on the magnitude of the detection vibration signal by the environment determination unit 670. Therefore, the notice controller 680 controls the notice sound signal generation unit 551 or the notice vibration signal generation unit 561 to generate the notice sound signal or the notice vibration signal based on the magnitude of the detection vibration signal.

### Example of Operations of Mobile Phone 500

Next, the operations of the mobile phone 500 according to the third embodiment of the invention are described with reference to the drawings.

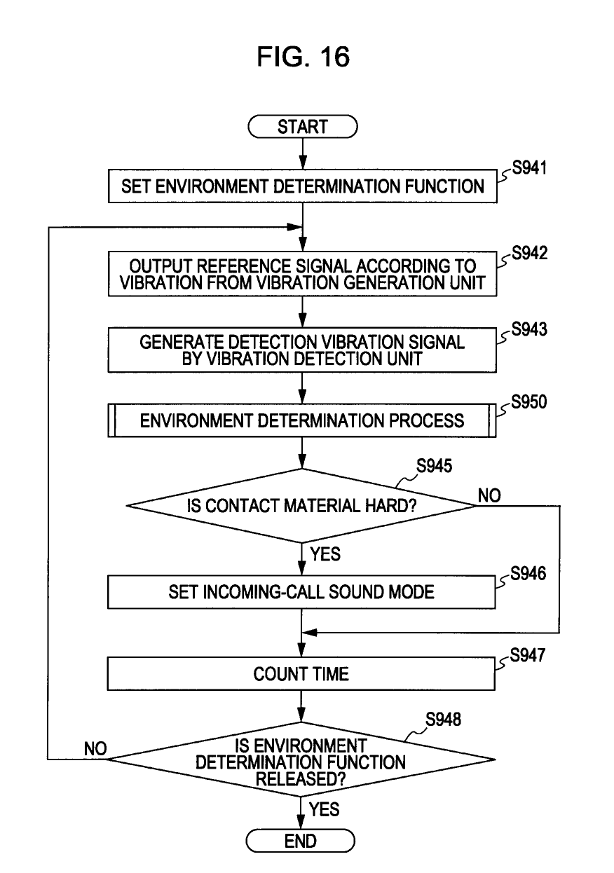

FIG. 16 is a flowchart illustrating an example of a procedure of a notice control method by an environment determination function of the mobile phone 500 according to the third embodiment of the invention.

First, in the manipulation reception unit 180, manipulation for setting the environment determination function is received (Step S941). Next, according to the instruction from the call-incoming mode switching unit 600, the vibration generated by the reference signal output unit 620 is output as a reference signal (Step S942). In addition, Step S942 is an example of a reference signal output procedure disclosed in Claims.

Next, the vibration of the mobile phone 500 generated based on the reference signal is detected by the vibration detection unit 610, so that the detection vibration signal is generated (Step S943). In addition, Step S943 is an example of a reference signal detection procedure disclosed in Claims.

Next, the environment determination process is performed by the environment determination unit 670 based on the detection vibration signal generated by the vibration detection unit 610 (Step S950). Next, the content of the determination information as the result of the determination of the environment determination unit 670 is determined by the notice controller 680 (Step S945).

Next, in the case where the determination information indicates that the contact material is hard, the notice controller 680 switches the call-incoming mode into the notice sound mode. (Step S946). In other words, the notice controller 680 controls one notice signal generation unit among a plurality of the notice signal generation units to generate the notice signal based on the detection signal generated by the vibration detection unit 610. On the other hand, in the case where the determination information indicates that the contact material is soft, the procedure proceeds to Step S947. In addition, Steps S945, 5946, and S950 are an example of notice control procedure disclosed in Claims.

Next, time is measured by the notice controller 680 (Step S947), and after a predetermined time is passed, it is determined whether or not the environment determination function is released (Step S948). Next, in the case where the environment determination function is not released, the procedure returns to Step S942, and a series of processes are repeatedly performed until the environment determination function is released. On the other hand, if the environment determination function is released, the notice control process according to the environment determination function is ended.

### Example of Environment Determination Process by Call-Incoming Mode Switching Unit 600

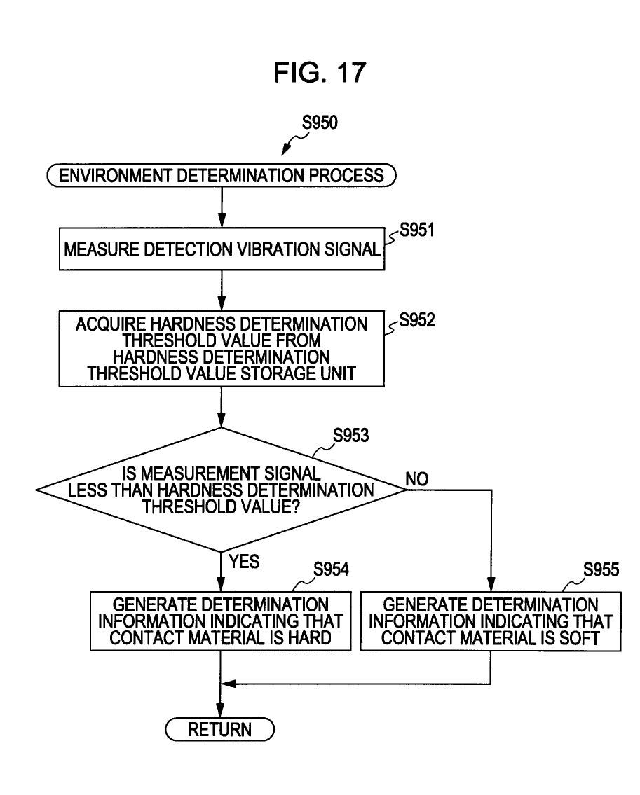

FIG. 17 is a flowchart illustrating an example of a procedure of an environment determination process (Step S950) by the call-incoming mode switching unit 600 according to the third embodiment of the invention.

First, the detection vibration signal supplied from the vibration detection unit 610 is measured by the detection signal measurement unit 630, so that a measurement signal is generated (Step S951). Next, the hardness determination threshold value stored in the hardness determination threshold value storage unit 660 is acquired by the environment determination unit 670 (Step S952). Subsequently, the environment determination unit 670 determines whether or not the signal level of the measurement signal generated by the detection vibration signal measurement unit is smaller than the acquired hardness determination threshold value (Step S953).

Next, in the case where the signal level of the measurement signal is smaller than the hardness determination threshold value, determination information indicating that the contact material is soft as a determination result is generated by the environment determination unit 670 (Step S954). On the other hand, in the case where the signal level of the measurement signal is equal to or larger than the hardness determination threshold value, determination information indicating that the contact material is hard as a determination result is generated by the environment determination unit 670 (Step S955). After the generation of the determination information is ended, the operations of the environment determination process are ended.

In this manner, in the third embodiment of the invention, the vibration of the mobile phone 500 according to the reference signal from the reference signal output unit 620 may be detected by the vibration detection unit 610, and it may be determined based on the magnitude of the detection vibration signal whether or not the contact material is hard. Therefore, in the case where the contact material for the mobile phone 500 is determined to be hard by the environment determination unit 670, the call-incoming mode may be set to the notice sound mode.

In addition, herein, in the case where the contact material is determined to be hard by the environment determination unit 670, the example where the call-incoming mode is switched from the notice vibration mode to the notice sound mode is described. However, in the case where the contact material is determined to be soft, the call-incoming mode may be set to the notice vibration mode. For example, when the mobile phone 500 together with clothes is received in a bag, the notice vibration is absorbed into the clothes, so that the user may not perceive the notice vibration. In this case, when the contact material for the mobile phone 500 is determined to be hard by the environment determination unit 670, the call-incoming mode of the mobile phone 500 is switched from the notice vibration mode to the notice sound mode, so that the incoming call may be easily perceived by the user.

In this manner, as the switch condition for setting the call-incoming mode of the mobile phone 500 to the notice sound mode by using the environment determination function, a condition that the contact material is hard, or a condition that the contact material is soft may be selected differently according to the environment of the mobile phone 500 or the user's desire. Therefore, in the case of setting the environment determination function, the switch condition may be configured to be set in advance by the user.

In addition, in the third embodiment of the invention, an example where the environment of the mobile phone 500 is determined based on the magnitude of the detection vibration signal is described. However, in this example, since only the magnitude of the detection vibration signal is used as the object of the determination, it is difficult to set the hardness determination threshold value. This is because the absorbance or reflectance of the vibration of the mobile phone 500 is varied according to the type of the contact material for the mobile phone 500. On the contrary, in the below-described fourth embodiment, an improved configuration where the environment of the mobile phone 500 is determined based on the frequency components of the detection vibration signal is described.

### 4. Fourth Embodiment

### Example of Configuration of Call-Incoming Mode Switching Unit

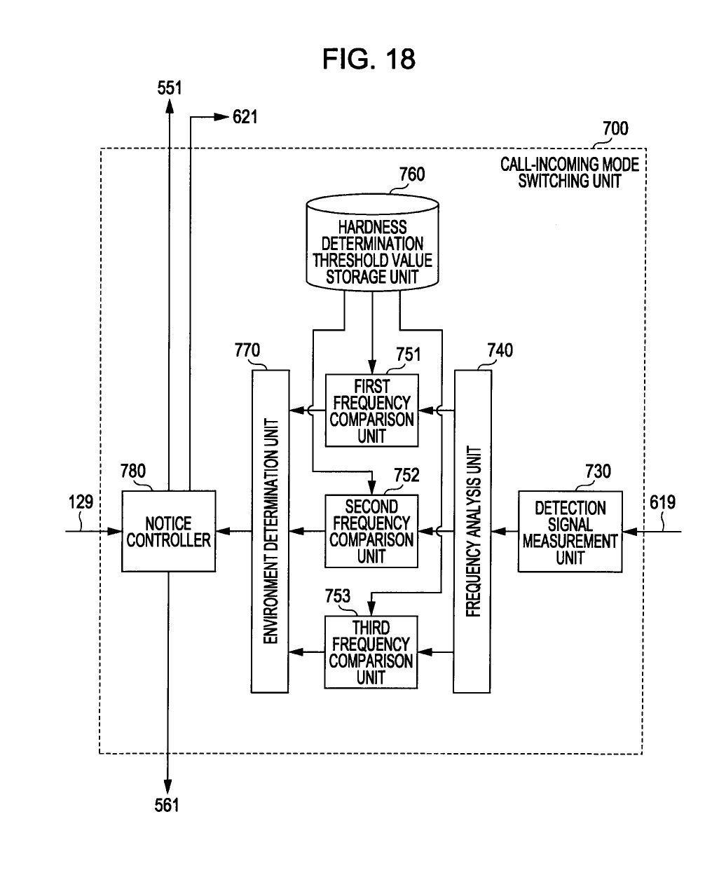

FIG. 18 is a block diagram illustrating an example of a configuration of a call-incoming mode switching unit 700 according to a fourth embodiment of the invention.

The call-incoming mode switching unit 700 includes a detection signal measurement unit 730, a frequency analysis unit 740, first to third frequency comparison units 751 to 753, a hardness determination threshold value storage unit 760, an environment determination unit 770, and a notice controller 780. The call-incoming mode switching unit 700 corresponds to the call-incoming mode switching unit 600 illustrated in FIG. 12. In addition, since the detection signal measurement unit 730 of the call-incoming mode switching unit 700 is the same as the detection signal measurement unit 630 illustrated in FIG. 13, the description thereof is omitted.

The frequency analysis unit 740 is used to analyze the measurement signal supplied from the detection signal measurement unit 730. In other words, the frequency analysis unit 740 generates the frequency components of the measurement signal by converting the measurement signal supplied from the detection signal measurement unit 730 from a time area to a frequency area. The frequency analysis unit 740 calculates a distribution of the frequency components of the measurement signal by using, for example, a fast Fourier transform (FFT).

In addition, the frequency analysis unit 740 supplies the values of the powers of the frequency components corresponding to the predetermined first to third frequencies among the calculated frequency components as the first to third frequency levels to the first to third frequency comparison units 751 to 753. In other words, the frequency analysis unit 740 supplies the first frequency level to the first frequency comparison unit 751, supplies the second frequency level to the second frequency comparison unit 752, and supplies the third frequency level to the third frequency comparison unit 753.

The first to third frequency comparison units 751 to 753 compares the first to third frequency levels supplied from the frequency analysis unit 740 and the first to third hardness determination threshold values stored in the hardness determination threshold value storage unit 760.

The first frequency comparison unit 751 compares the first frequency level and the first hardness determination threshold value and supplies the comparison result as a first comparison result to the environment determination unit 770. For example, in the case where the first frequency level is equal to or larger than the first hardness determination threshold value, the first frequency comparison unit 751 outputs the H level as a first comparison result to the environment determination unit 770. In the case where the first frequency level is smaller than the first hardness determination threshold value, the first frequency comparison unit 751 outputs the L level as the first comparison result to the environment determination unit 770.

The second frequency comparison unit 752 compares the second frequency level and the second hardness determination threshold value and supplies the comparison result as a second comparison result to the environment determination unit 770. For example, in the case where the second frequency level is equal to or larger than the second hardness determination threshold value, the second frequency comparison unit 752 outputs the H level as a second comparison result to the environment determination unit 770. In the case where the second frequency level is smaller than the second hardness determination threshold value, the second frequency comparison unit 752 outputs the L level as the second comparison result to the environment determination unit 770.

The third frequency comparison unit 753 compares the third frequency level and the third hardness determination threshold value and supplies the comparison result as a third comparison result to the environment determination unit 770. For example, in the case where the third frequency level is equal to or larger than the third hardness determination threshold value, the third frequency comparison unit 753 outputs the H level as a third comparison result to the environment determination unit 770. In the case where the third frequency level is smaller than the third hardness determination threshold value, the third frequency comparison unit 753 outputs the L level as the third comparison result to the environment determination unit 770.

The hardness determination threshold value storage unit 760 stores the first to third hardness determination threshold values corresponding to the first to third frequency components of the measurement signal. The hardness determination threshold value storage unit 760 outputs the first hardness determination threshold value to the first frequency comparison unit 751, outputs the second hardness determination threshold value to the second frequency comparison unit 752, and outputs the third hardness determination threshold value to the third frequency comparison unit 753.

The environment determination unit 770 determines based on the first to third comparison results supplied from the first to third frequency comparison units 751 to 753 whether or not the contact material for the mobile phone 500 is hard. For example, in the case where all the first to third comparison results are the H level, the environment determination unit 770 determines that the contact material for the mobile phone 500 is hard.

On the other hand, in the case where at least one of the first to third comparison results is the L level, the environment determination unit 770 determines that the contact material for the mobile phone 500 is soft. In another example, in the case where at least one of the first to third comparison results is the H level, the environment determination unit 770 may determine that the contact material for the mobile phone 500 is hard; and in the other cases, the environment determination unit 770 may determines that the contact material is soft.

In addition, the environment determination unit 770 supplied the result of the determination to the notice controller 780. As an example of the result of the determination, in the case where the contact material is determined to be hard, the environment determination unit 770 generates determination information indicating that the contact material is hard. In the case where the contact material is determined not to be hard, the environment determination unit 770 generates determination information indicating that the contact material is soft. Next, the environment determination unit 770 supplies the generated determination information as the result of the determination to the notice controller 780.

In the case where the incoming call signal is supplied from the control line 129, the notice controller 780 allows one of the notice sound signal generation unit 551 and the notice vibration signal generation unit 561 to generate the notice signal according to the call-incoming mode determined by the result of the determination of the environment determination unit 770. In other words, the notice controller 780 controls one notice signal generation unit among a plurality of the notice signal generation units to generate the notice signal based on the frequency components of the detection vibration signal generated by the vibration detection unit 610. In addition, since the other functions of the notice controller 780 are the same as those of the notice controller 680, the description thereof is omitted.

In this manner, the call-incoming mode switching unit 700 may determine the environment of the mobile phone 500 based on the frequency components of the measurement signal generated by the frequency analysis unit 740 and the hardness determination threshold values corresponding to the frequency components. In addition, although an example where the environment of the mobile phone 500 is determined based on the three frequency components among the frequency components of the measurement signal by the first to third frequency comparison units 751 to 753 is described herein, the invention is not limited thereto. Next, a detailed example of the environment determination method using the call-incoming mode switching unit 700 is described with reference to the drawings.

### Example of Environment Determination Based on Frequency Component of Measurement Signal

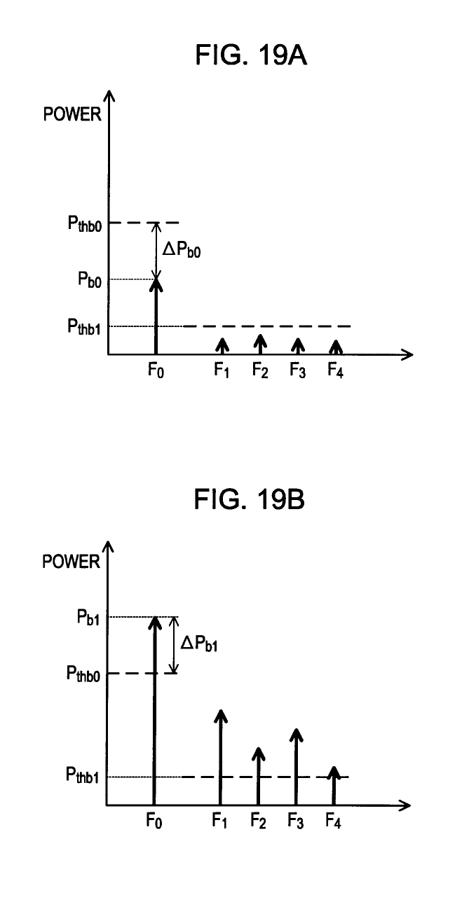

FIGS. 19A and 19B are diagrams illustrating an example of the environment determination based on a frequency component of a measurement signal by the call-incoming mode switching unit 700 according to the fourth embodiment of the invention.

FIG. 19A illustrates first to fifth frequency components (F₀ to F₄) among the frequency components of the measurement signal in the state illustrated in FIG. 14A. FIG. 19B illustrates the first to fifth frequency components (F₀ to F₄) among the frequency components of the measurement signal in the state illustrated in FIG. 14B. Herein, it is assumed that the reference signal constructed with the first frequency component (F₀) is output from the reference signal output unit 620. In addition, herein, the vertical axis indicates a power, and the horizontal axis indicates a frequency.

In FIG. 19A, the first to fifth frequency components (Fₒ to F₄) for a soft contact material and the first and second hardness determination threshold values (P_{thb0} to P_{thb1}) are illustrated.

In the case where the mobile phone 500 is not in contact with an object, the first and second hardness determination threshold values (P_{thb0} and P_{thb1}) are set based on the frequency components of the measurement signal measured by the detection signal measurement unit 630. In this example, the first hardness determination threshold value (P_{thb0}) is the hardness determination threshold value corresponding to the first frequency (F₀). The second hardness determination threshold value (Pₜₕ₁) is the hardness determination threshold value corresponding to the second to fifth frequencies (F₁ to F₄).

With respect to the first to fifth frequency components (F₀ to F₄) for the soft contact material, the first to fifth frequency levels indicating the values of the powers thereof are smaller than the corresponding first and second hardness determination threshold values (P_{thb0} to P_{thb1}). This is because the first to fifth frequency components (F₀ to F₄) which are the vibration components of the mobile phone 500 are absorbed by the soft contact material 820. For example, the first frequency level (P_{b0}) corresponding to the first frequency (F₀) for the soft contact material is smaller than the first hardness determination threshold value (P_{thb0}) by an attenuated level difference (ΔP_{b0}).

In addition, since the vibration is absorbed into the soft contact material 820, the second to fifth frequency levels are smaller than the second hardness determination threshold value (P_{thb0}) similarly to the first frequency level (P_{b0}) for the soft contact material. In addition, the second to fifth frequency components (F₁ to F₄) are the vibration accuracy of the vibration generation unit 622 or the frequency components generated by vibrating the mobile phone 500.

In this case, since all the first to fifth frequency levels for the soft contact material are smaller than the corresponding first and second hardness determination threshold values (Pₜₕ₀ and Pₜₕ₁), the environment determination unit 770 determines that the contact material is soft.

In FIG. 19B, the first to fifth frequency components (Fₒ to F₄) for the hard contact material and the first and second hardness determination threshold values (P_{thb0} to P_{thb1}) are illustrated. Herein, since the first and second hardness determination threshold values (P_{thb0} and P_{thb1}) are the same as those of FIG. 19A, the description thereof is omitted.

Since the vibration is amplified by the hard contact material 830, the first to fifth frequency levels of the first to fifth frequency components (F₀ to F₄) for the hard contact material are larger than the corresponding first and second hardness determination threshold values (P_{thb0} and P_{thb1}). For example, the first frequency level (P_{b1}) corresponding to the first frequency (F₀) for the hard contact material is larger than the first hardness determination threshold value (P_{thb0}) by an amplified level difference (ΔP_{b1}).

In addition, since the vibration is amplified by the hard contact material 830, the second to fifth frequency levels are also larger than the second hardness determination threshold value (P_{thb1}) similarly to the first frequency level (P_{b1}) for the hard contact material. For example, the second to fifth frequency components (F₁ to F₄) are the resonance frequencies and harmonics components other than the resonance frequencies which are generated by the contact between the mobile phone 500 and the hard contact material 830 due to the vibration of the reference signal.

In this case, since all the first to fifth frequency levels of the hard contact material are equal to or larger than the corresponding first and second hardness determination threshold values (Pₜₕ₀ and Pₜₕ₁), the contact material is determined to be hard by the environment determination unit 770.

In this manner, by comparing the frequency component of the measurement signal with the first and second hardness determination threshold values (P_{thb0} and P_{thb1}), the environment determination unit 770 may determine whether or not the contact material for the mobile phone 500 is hard. In other words, the environment of the mobile phone 500 may be determined based on the frequency component of the detection vibration signal by the environment determination unit 770.

Therefore, unlike the environment determination unit 670 according to the third embodiment, since the environment is determined based on a plurality of the frequency components, the erroneous determination of the environment determination unit 770 may be reduced. In other words, since the variation in the frequency component as well as the frequency component (F₀) of the reference signal is detected, the determination of the environment of the mobile phone 500 may be more accurately performed. In addition, although an example where the frequency levels of the pre-designated frequency components and the hardness determination threshold values are compared is described herein, the environment of the mobile phone 500 may be determined based on the number of the frequency components that exceed the second hardness determination threshold value (Pₜₕ₁). Next, the operations of the call-incoming mode switching unit 700 are described with reference to the drawings.

### Example of Environment Determination by Call-Incoming Mode Switching Unit 700

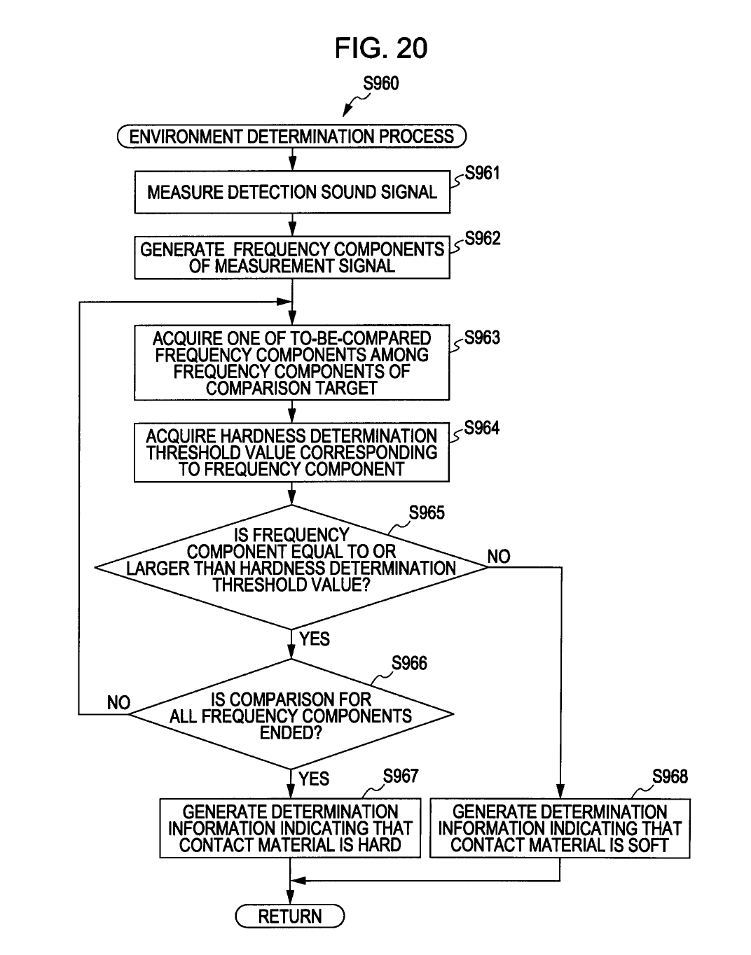

FIG. 20 is a flowchart illustrating an example of a procedure of an environment determination process (Step S960) by the call-incoming mode switching unit 700 according to the fourth embodiment of the invention. The environment determination process (Step S960) corresponds to the environment determination process (Step S960) illustrated in FIG. 16.

First, the detection vibration signal is measured by the detection signal measurement unit 730, so that the measurement signal is generated (Step S961). Next, the frequency component of the measurement signal supplied from the detection signal measurement unit 730 is generated by the frequency analysis unit 740 (Step S962). In other words, a frequency level indicating a value of the power for each frequency component is calculated by the frequency analysis unit 740.

Next, a first frequency level from the frequency analysis unit 740 is acquired by a first frequency comparison unit 751 (Step S963). In addition, the first hardness determination threshold value corresponding to the first frequency level among the first to third hardness determination threshold values stored in the hardness determination threshold value storage unit 760 is acquired by the first frequency comparison unit 751 (Step S964). Next, in the first frequency comparison unit 751, it is determined whether or not the first frequency level is smaller than the first hardness determination threshold value (Step S965).

Next, in the case where the first frequency level is smaller than the first blockage value, since the L level as the first comparison result is output from the first frequency comparison unit 751, the determination information indicating that the contact material is soft is generated by the environment determination unit 770 (Step S968). On the other hand, in the case where the first frequency level is equal to or larger than the first blockage value, the environment determination unit 770 determines whether or not all the comparison results for the frequency components as the comparison objects are acquired from the first to third frequency comparison units 751 to 753 (Step S966).

Next, in the case where all the comparison results are acquired, the determination information indicating that the contact material is hard is generated by the environment determination unit 770 (Step S967). On the other hand, in the case where all the comparison results are not acquired, the procedure returns to Step S932, and the second frequency level and the second hardness determination threshold value corresponding to the frequency component are acquired and compared by the second frequency comparison unit 752.

In this manner, until the frequency levels as the comparison objects are smaller than the hardness determination threshold values corresponding to the frequency levels, all the comparisons of the first to third frequency comparison units 751 to 753 are sequentially performed. Next, in the case where all the frequency levels of the frequency components as the comparison objects are equal to or larger than the corresponding hardness determination threshold values, the determination information indicating that the contact material is hard is generated. In the other cases, the determination information indicating that the contact material is soft is generated, and the environment determination process is ended.

In this manner, in the fourth embodiment according to the invention, it is possible to determine based on the frequency components of the measurement signal generated from the detection vibration signal of the vibration detection unit 610 whether or not the contact material for the mobile phone 500 is hard. In other words, the environment of the mobile phone 500 is determined based on the frequency components of the detection vibration signal, and the call-incoming mode of the mobile phone 500 may be set to the notice vibration mode according to the result of the determination.

In addition, in the third and fourth embodiments of the invention, although an example where the reference signal is output from the reference signal output unit 620 in a predetermined time interval is described, the reference signal may be output based on a motion of the mobile phone 500. In this example, a displacement, a velocity, and an acceleration of the mobile phone 500 as the motion thereof is detected by the vibration detection unit 610, and when the detected motion exceeds a predetermined motion threshold value, the reference signal is allowed to be output from the reference signal output unit 620. Hereinafter, an example where the reference signal is output based on the motion of the mobile phone 500 detected by the vibration detection unit 610 according to the fifth embodiment is described with reference to a flowchart.

### 5. Fifth Embodiment

### Example of Operations of Mobile Phone 500 Outputting Reference Signal According to Motion Detection

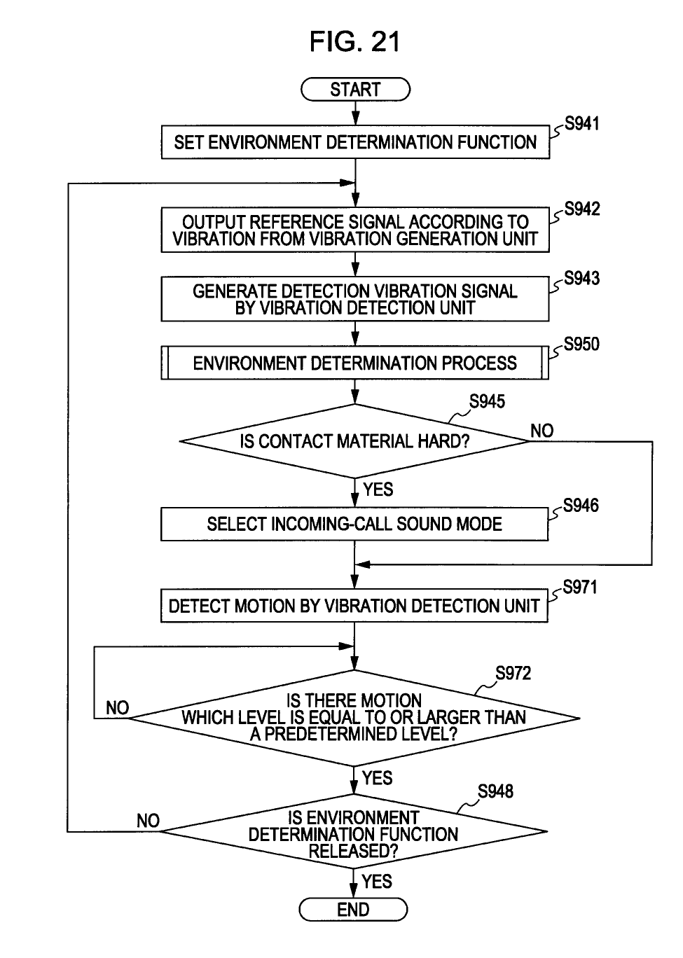

FIG. 21 is a flowchart illustrating an example of a procedure of a notice control method by an environment determination function of a mobile phone 500 according to a fifth embodiment of the invention. Herein, instead of Step S947 in FIG. 16, Steps S971 and 5972 are illustrated. In addition, since the process other than Steps S971 and S972 are the same as those of FIG. 16, the description thereof is omitted.

After the process of Step S945 or 5956, the motion of the mobile phone 500 is detected by the vibration detection unit 610 (Step S971). For example, a displacement, a velocity, or an acceleration of the mobile phone 500 as the magnitude of the motion thereof is detected by the vibration detection unit 610. Next, it is determined whether or not the motion of the mobile phone 500 is detected by the vibration detection unit 610 (Step S972). In other words, it is determined whether or not the magnitude of the motion detected by the vibration detection unit 610 exceeds a predetermined motion threshold value. For example, it is determined whether or not the displacement, the velocity, or the acceleration detected by the vibration detection unit 610 exceeds the motion threshold value.

Next, in the case where the magnitude of the motion detected by the vibration detection unit 610 exceeds the motion threshold value, the procedure proceeds to Step S948, and if the environment determination function is not released, the reference signal in Step S942 is output. On the other hand, in the case where the magnitude of the motion detected by the vibration detection unit 610 does not exceed the motion threshold value, the process of Step S948 is not performed until the magnitude of the motion exceeds the motion threshold value.

In this manner, since the reference signal is output from the reference signal output unit 620 based on the magnitude of the motion of the mobile phone 500 by using the vibration detection unit 610, so that a problem in that the reference signal is output in the state where the environment of the mobile phone 500 is not changed may be lessened. Accordingly, since the useless outputting of the reference signal may be suppressed, power consumption of the mobile phone 500 may be decreased. In addition, user's misunderstanding of the vibration according to the reference signal as the incoming call may be reduced.

In addition, although the mobile phone 500 is exemplified herein, the vibration detection unit 610 for detecting the motion may be provided to the mobile phone 100. Therefore, the mobile phone 100 may allow the reference signal output unit 220 of the mobile phone 100 to output the reference signal based on the magnitude of the motion detected by the vibration detection unit 610.

In this manner, according to the embodiments of the invention, the reference signal is output from the reference signal output unit 220 or 620, and the detection signal based on the reference signal is used by the sound detection unit 210 or the vibration detection unit 610, so that the mobile phone may be switched to an optimized call-incoming mode.

In addition, according to the embodiments of the invention, although the mobile phone 100 or 500 is exemplified, the invention is adapted to a notice apparatus of which use environment is changed. For example, the invention is adapted to a notice apparatus, which notifies an alarm by various methods using vibration, sound or the like, such as a PDA (Personal Digital Assistants), a portable sound player, or a measurement apparatus.

In addition, the embodiments of the invention are exemplary ones for implementing the invention. Therefore, as described above in the embodiments of the invention, the components and configurations of the embodiments have correspondence with those disclosed in the claims. Similarly, the components and configurations of the claims also have correspondence with those indicated by the same names in the embodiments of the invention. The invention is not limited to the aforementioned embodiments, but various modifications are available within the scope without departing from the spirit of the invention.

In addition, the procedure described in the embodiment of the invention may be considered to be a method having a series of processes, a program for executing a series of the processes in a computer, or a recording medium storing the program. As an example of the recording medium, a CD (Compact Disc), a MD (Mini Disc), a DVD (Digital Versatile Disk), a memory card, a Blu-ray Disc (registered trade mark), and the like may be used.

The present application contains subject matter related to that disclosed in Japanese Priority Patent Application JP 2009-123995 filed in the Japan Patent Office on May 22, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A notice apparatus comprising:
a plurality of notice signal generation units which generate notice signals;
a reference signal output unit which outputs a reference signal used to determine an environment situation;
a reference signal detection unit which detects the reference signal output from the reference signal output unit and generates the detected reference signal as a detection signal; and
a notice controller which controls one of the notice signal generation units to generate the notice signal based on the detection signal generated by the reference signal detection unit.

2. The notice apparatus according to claim 1,
wherein the reference signal output unit outputs a sound signal as the reference signal,
wherein the reference signal detection unit detects the sound signal output from the reference signal output unit and generates the detection signal from the detected sound signal, and
wherein the notice controller controls one of the notice signal generation units to generate the notice signal based on the detection sound signal generated as the detection signal by the reference signal detection unit.

3. The notice apparatus according to claim 2, wherein the notice controller controls one of the notice signal generation units to generate the notice signal based on a magnitude of the detection sound signal.

4. The notice apparatus according to claim 2, wherein the notice controller controls one of the notice signal generation units to generate the notice signal based on frequency components of the detection sound signal.

5. The notice apparatus according to claim 2,
wherein the reference signal output unit outputs the sound signal constructed with predetermined frequency components, and
wherein the notice controller controls one of the notice signal generation units to generate the notice signal based on the predetermined frequency components of the detection sound signal.

6. The notice apparatus according to claim 5, wherein the reference signal output unit outputs the sound signal constructed with the predetermined frequency components outside a voice band.

7. The notice apparatus according to claim 1,
wherein the reference signal output unit outputs the reference signal generated based on vibration,
wherein the reference signal detection unit detects the vibration output from the reference signal output unit and generates the detected vibration as the detection signal, and
wherein the notice controller controls one of the notice signal generation units to generate the notice signal based on a detection vibration signal generated as the detection signal by the reference signal detection unit.

8. The notice apparatus according to claim 7, wherein the notice controller controls one of the notice signal generation units to generate the notice signal based on a magnitude of the detection vibration signal.

9. The notice apparatus according to claim 7, wherein the notice controller controls one of the notice signal generation units to generate the notice signal based on frequency components of the detection vibration signal.

10. The notice apparatus according to claim 7,
wherein the notice signal generation unit generates the notice vibration signal as the notice signal to generate the vibration for notice, and
wherein the reference signal output unit outputs the vibration of which a magnitude is smaller than a magnitude of the notice vibration generated based on the notice vibration signal.

11. A method of controlling a notice in a notice apparatus having a plurality of notice signal generation units which generate notice signals, comprising the steps of:
outputting a reference signal used to determine an environment situation;
detecting the reference signal output in the outputting of the reference signal and generating the detected reference signal as a detection signal; and
controlling one of the notice signal generation units to generate the notice signal based on the detection signal generated in the detecting of the reference signal.

12. A program for a notice apparatus having a plurality of notice signal generation units which generate notice signals, causing a computer to execute:
a reference signal output process of outputting a reference signal used to determine an environment situation;
a reference signal detection process of detecting the reference signal output in the reference signal output process and generating the detected reference signal as a detection signal; and
a notice control process of controlling one of the notice signal generation units to generate the notice signal based on the detection signal generated in the reference signal detection process.
